(19) United States
(12) Patent Application Publication
(10) Pub. No.: US 2026/0109031 A1
(43) Pub. Date: Apr. 23, 2026

(54) A Fabric-Handling Dual-Manipulator System with Fabric Rolling-Up End-Effectors

(71) Applicant: CENTRE FOR GARMENT PRODUCTION LIMITED, Hong Kong (CN)

(72) Inventors: Kazuhiro KOSUGE, Hong Kong (CN); Akinari KOBAYASHI, Hong Kong (CN)

(73) Assignee: CENTRE FOR GARMENT PRODUCTION LIMITED, Hong Kong (CN)

(21) Appl. No.: 19/117,624

(22) PCT Filed: Apr. 25, 2023
(86) PCT No.: PCT/CN2023/090533

§ 371 Date: Apr. 1, 2025

(30) Foreign Application Priority Data
Oct. 10, 2022 (WO) PCTCN2022124326

(51) Int. Cl. B25J 9/16; B25J 9/00; B25J 13/08; B25J 15/06

(52) U.S. Cl. CPC B25J 9/1633; B25J 9/0018; B25J 9/1682; B25J 9/1697; B25J 13/085; B25J 15/0616

(57) ABSTRACT

A fabric handling manipulator system for handling a subject fabric part includes a first robot manipulator and a first rolling-up end-effector positioned by the first robot manipulator. The first rolling-up end-effector is configured and adapted to grasp a first end of the subject fabric part with a first roller having a first suction port. A first force sensor is configured and adapted to sense a force applied to the first rolling-up end-effector. The system further includes a vision sensor system configured and adapted to sense a fabric part pose of the subject fabric part and a first pose of the first rolling-up end-effector. A controller is configured and adapted to simultaneously control the fabric part pose and a tension in the fabric part via the first robot manipulator according to inputs from the vision sensor system and the first force sensor.

### CROSS-REFERENCE TO RELATED APPLICATION

This application is a U.S. National Stage Application under 35 U.S.C. § 371 of International Patent Application No. PCT/CN2023/090533 filed Apr. 25, 2023 (and published as WO/2024/077926 A1 on April 18, 2024), which claims the benefit of priority from International Patent Application No. PCT/CN2022/124326, filed Oct. 10, 2022 (and published as WO/2024/077436 A1 on April 18, 2024), both of which are incorporated herein by reference in their entireties.

### FIELD OF THE INVENTION

The present application relates, generally, to automated fabric manipulators and, more particularly to fabric manipulators that employ end-effectors.

### BACKGROUND OF THE INVENTION

Most garment production processes that require the precise manipulation of fabric parts, such as sewing operations, are still manually performed by human workers. Fabrics are challenging to manipulate because they are thin, soft, flexible, and deformable, and therefore dexterous human hands are needed for fabric handling operations.

To enhance production efficiency, part of garment production processes are performed with automation systems. Existing automation systems for sewing or handling operations require a fixture that is custom designed to clamp a fabric part of a specific size and shape. The fixture holds the fabric part and uniquely determines the fabric part's pose with respect to the fixture's pose. The sewing operation, for instance, is carried out by manipulating the position of the fixture, which provides guiding slots that constrain the paths of stitching, relative to a sewing needle. The fabric part clamped by the fixture receives adequate mechanical support to retain its shape, rendering it more readily handled by automation systems. This automation style that uses fixtures is efficient for mass production of a garment with the same design. Nevertheless, it suffers from several drawbacks. Common issues with the use of fixtures include (i) the fact that each fixture is only applicable to fabric parts of a particular size and shape, but not to other dissimilar fabric parts, so that the automation systems require a customized fixture for each type of target fabric part to be sewn or processed, (ii) the fabrication of such fixtures involves extra time and cost, and (iii) the installation and replacement of the fixtures between production runs involves extra time and cost.

Robotic gripping devices for handling flexible fabric materials without a customized fixture have been investigated and reported by various research groups worldwide since the 1980s. These reported devices may roughly be categorized according to their enabling mechanisms, including mechanical, electrostatic, airflow, adhesive, and rotatable drum techniques.

### I. Mechanical Techniques

Robotic grippers adopting the typical “2-finger” construction have most frequently been studied for fabric handling due plausibly to its common use in conventional robotic systems. Depending on design variations, these mechanical grippers may perform clamping, pinching and sometimes hooking with the aid of additional pins/needles. The grasping is facilitated by small-area contacts or even point contacts. Several research groups that have attempted to handle fabric parts of different sizes and shapes using mechanical grippers (and no fixtures) have been identified. A number of recent examples are outlined below.

In Schrimpf (2015), a system having “2-finger” mechanical grippers mounted on robotic arms is shown to be able to maneuver fabric parts with respect to a sewing machine. However, the setup can only move the fabric parts but cannot vary the tension of individual fabric parts.

Stria (2014) and L. Sun (2015) utilized an identical dual-manipulator robot system under the CloPeMa (Clothes Perception and Manipulation) project with a “2-finger” gripper and a camera mounted on each robotic manipulator. It was employed to fold a garment article by picking up the article at its corners. The operation was assisted by visual information. No tension control is reported.

Shibata (2009, 2012) reported a setup which consists of “2-finger” grippers mounted on a linear rail. It is used to “pinch and grasp” a piece of fabric at one location and to release the same in another location. This design suffers from the drawback that only linear relative motion of the grippers is allowed, and force sensing is absent. Even if tension control could be implemented in such a system, the tension is only able to be applied along a straight line delimited by the linear rail.

Aranda (2020) presents a work focused on shape-serving, where a “2-finger” gripper is used for handling deformable objects with the help of computer vision.

Tanaka (2021) also presents a robotic setup which uses “2-finger” grippers to perform fabric folding. Its major difference with the other related art setups lies in the use of a humanoid robot while the working principle of the end-effectors is similar.

Ku (2020) reported a special design of fabric gripper with embedded micro-needles and suction. The grasping strategy entails pinching with two jaws to buckle the fabric and lifting the fabric by means of suction. Such a design has not been shown (and is not expected) to be effective in maneuvering/positioning the fabric due to its limited gripping force and minute area of contact with the fabric.

The end-effector developed by Yamazaki (2021) teaches brush-like rollers to enhance the grip of fabric objects. No suction is used in this design. Although rolling-up of fabric is involved in the operation, the amount of rolling is severely limited by the end-effector's design. And further, once the fabric tissues are engaged and interlocked by the bristle elements on the roller, releasing the fabric can become problematic.

Hinwood (2020) teaches another end-effector design derived from the gesture of human fingers which may provide a more secure grip of fabrics. Apart from this, the device works essentially the same way as a common “2-finger”gripper.

### II. Electrostatic techniques

Electrostatic adhesion has been utilized to handle fabric materials. An example is given by B. Sun (2019), where an electrostatic gripper device having multiple electro adhesion pads is used to acquire fabric panels. Weak adhesion force is among the perceived disadvantages of these electrostatic grippers. Also, the surface area of this type of gripper has to be comparable to the size of the fabric panel in order to handle the fabric in a secure manner.

### III. Air-flow Techniques

Apart from directly applying a vacuum suction, end-effectors with regulated air-flow (or air-jets) may also create a negative-pressure effect that attracts fabric materials based on the Bernoulli's principle. Ozcelik (2003) has developed a “non-contact” end-effector for handling materials including fabrics, using a radial outbound air flow.

Here, in the absence of physical contact, the stability of the fabric during lifting and transferring processes is reasonably uncertain. Under frictional drag the airstream leaving the fabric may become turbulent and cause undesirable vibrations at the free edges/corners of thin and light fabrics. This is detrimental to precise positioning. Another issue with such a device is that the “suction zone” produced by the nozzle is usually limited. To increase the area of the “suction zone”, the nozzle needs to be upsized and the maintenance of laminar air flow, where the attraction force is derived from, will become more difficult at a larger scale of flow.

### IV. Adhesive Techniques

Another known type of end-effectors for fabric handling is based on glue or adhesive tapes. Typical design of the device consists of a tape dispenser and a motorized feeding mechanism, as shown in the paper published by Parker et al (1983).

The adhesive gripper offers advantages including simplicity of design and a lower likelihood of picking up more than one fabric ply at a time from a stack of plies. Nevertheless, it requires an effective release mechanism to disengage the fabric from the adhesive, which adds complexity to the mechanical designs and process control, and which has seldom been studied or reported in the literature.

### V. Rotatable Drum Techniques

U.S. Pat. No. 7,601,237 B2 relates to an apparatus, robot system, and method for handling fabrics to construct composite materials for aircraft. The apparatus is composed of a rotatable drum assembly with one or more vacuum ports on the drum surface. The robot system consists of a movable gantry-type frame, a robotic arm attached to the frame, and apparatus attached to the endpoint of the robotic arm.

A similar apparatus and method for handling flexible materials is disclosed by the patent publication application US 2018/0154539 A1. The subject system picks up cut pieces of a flexible material. The system comprises a pick head, a positioner of the pick head, and a table on which a flexible material is located. The pick head is composed of a rotatable cylinder with multiple vacuum orifices.

Both of the above systems use suction force to first acquire a target material placed on a table, then roll up the material around the drum or the cylinder surface.

### VI. Additional Commercial References

Very few companies are developing automation technology for fabric handling without customized fixtures. SoftWear Automation, Inc. and Sewbo, Inc. have developed automated garment production systems and methods, as follows.

Sewbots developed by SoftWear Automation, Inc. (Atlanta, GA) are fully automated garment production systems for various garment products, such as bathmats, pillowcases, jeans, dress-shirts, and T-shirts. The T-shirt Sewbot Workline produces T-shirts from pre-cut fabric parts without the need for any intervention from human workers. The production line mainly comprises a conveyor table, sewing units, and vision sensor systems. The conveyor table features a regular array of spherical rollers on the surface for transporting the fabric parts. Sewing operations are carried out at sewing units using the visual information acquired by the vision sensor systems.

Sewbo, Inc. (San Francisco, CA) developed a method to automate cloth manufacturing by temporarily stiffening fabric parts. A water-soluble stiffener (polyvinyl alcohol) makes the fabric parts rigid and easier to be handled by industrial robots. After the cloth manufacturing process is finished, the stiffener is removed by rinsing in hot water, followed by drying thoroughly to restore the original fabric texture.

### BRIEF SUMMARY OF THE INVENTION

Embodiments of the subject invention provide a novel end-effector and a robot system that is able to handle different fabric parts having dissimilar sizes and shapes, without the use of fixtures. In certain embodiments the provided robot system can include two or more robot manipulators each equipped with a force sensor and an end-effector, and a vision sensor system. The robot system is able to hold various types of fabric parts while keeping them flattened by one or both manipulators, which are operable to (i) grasp the fabric part and (ii) control the fabric part's tension. The manipulators can precisely position the grasped fabric part using the visual information captured by the vision sensor system. Then the handling operations of the fabric part can be executed. The entire handling process does not need any customized fixture, and the reconfiguration effort for changing to different product styles is minimized at the production line. Sewing paths can be numerically programmed, controlled, and visualized by the robot system.

Experiments to grasp fabric parts using a single robot manipulator and prototype of the end-effector have been conducted. The experimental results evidenced that a single end-effector is capable of grasping various fabric parts with different shapes. Fabric handling experiments using a dual-manipulator system have also been conducted to verify the functionality of the provided robot system. Embodiments using the fundamental design concept and physical construction of the system have been established, tested, and proven. Embodiments of the robotic apparatus and the fabric handling method are useful in commercial garment production procedures.

Existing automation systems for sewing or fabric handling operations employ a fixture that is designed to clamp a fabric part having a specific size and shape. The fixture uniquely determines the pose of the clamped fabric part and keeps it flattened. The pose of the clamped fabric part is precisely manipulated by positioning the fixture's pose. Each fixture is only applicable to fabric parts of the same size and shape, but not for fabric parts with other shapes or dimensions. As a result, the automation systems need an individual customized fixture for each type of target fabric part. Since preparing customized fixtures one by one is time and costly, conventional automation strategy using the fixtures is not suitable for flexible garment production, in particular high-mix low-volume production, where there is a need to handle differently shaped fabric parts as dictated by the production plan.

Embodiments of the subject invention provide an end-effector and a robot system for handling various fabric parts of different sizes or shapes, without fixtures. The provided robot system has one or more robot manipulators, each equipped with a force sensor and an end-effector, and a vision sensor system. The end-effector can have a roller unit with a suction port so that it can pick up a fabric part, roll it up, and facilitate transportation of it using the manipulator. After transportation, the end-effector can unroll and lay the fabric part flattened at a desired location. The end-effector can grasp various types of fabric parts with different dimensions by varying the strategy of rolling.

Certain embodiments advantageously employ a dual manipulator. A dual-manipulator system can comprise, consist essentially of, or consist of two robot manipulators (e.g., two robotic arms.) Dual-manipulator systems can provide advantageous configurations of the subject invention, in part because controllable tension can be effectively applied to the fabric to keep it in shape with the coordinated motion of two (or more) arms. Dual-manipulator systems are advantageously combined with embodiments of the rolling-up end-effectors to securely hold the target fabric part by grasping it on two sides (e.g., opposite sides) with the end-effectors. The force sensors attached to the manipulator can be used to control the tension applied to the handled fabric part and to flatten the fabric part without wrinkles and slacks during the positioning process (e.g., as shown in FIG. 1). The handled fabric part can be finally maneuvered to a target pose using the visual information captured by the vision sensor system. The provided robot system configuration, the mechanical structure of the robotic end-effector, and the method for handling fabric parts of different dimensions each provide advantages over related art systems and methods.

In related art, robotic grippers adopting various “2-finger” construction, airflow, electrostatic, adhesive, and rotatable drum techniques have been unable to effectively manage a wide range of fabric sizes and shapes despite the relatively complex mechanisms and larger footprints. In contrast, the suction-rollers of certain embodiments of the subject invention are able to deal with a wide range of sizes of fabric, yet with a comparatively smaller footprint. When operated in conjunction with a dual-manipulator and force (or torque) sensors, the suction-rollers can apply a uniform, controllable tension on the fabric to maintain its shape. These are major differences from related art of embodiments of the methods, robotic systems, and end-effectors of the present invention in terms of design and working principle.

One advantage of embodiments of the subject invention is that related art references teach a yoke frame or gantry that rotatably supports a roller on both ends, whereas the roller in certain embodiments of the subject invention is supported at one end only. This has numerous advantages, including a simpler mechanical structure that improves the roller's access to smaller-sized fabric parts and increases the effective working envelop of the end-effector.

The use of an internal roller shaft to support the outer roller is a differentiating feature advantageously employed in certain embodiments of the present invention. Related art may employ an internal tube that contains multiple branched portions for vacuum distribution. In certain related art the internal tube and branches are rotatable independently of the pick-up drum. In certain embodiments of the subject invention, the internal roller shaft (e.g., as shown in FIGS. 3B and 3C) serves the function of a suction passage as well as a support for the outer roller. It has no branched structures but has two (or more) slots running along its length that allows air to flow into it towards the vacuum source. In certain embodiments, the internal roller shaft is fixed and not rotatable. The outer roller contains one slot only whose position can be precisely controlled by the motor so that the slot can be advantageously controlled to face down prior to its engagement with the fabric part to be handled.

Unlike related art systems, embodiments of the present invention can distribute force and tension in a controlled manner through a subject fabric over a two-dimensional work space, which is advantageous for handling and positioning of fabrics.

Another advantageous embodiment of the outer roller can contain a slot of variable width (e.g., narrower at the proximal end and wider towards the distal end). One advantage of having a variable slot width design is that the vacuum source can be connected to the roller from the proximal end and the suction airflow, due to frictional loss, can decrease towards the distal end. Enlarging the port width at the distal end can enhance the airflow volume and in turn increase the magnitude of suctional force near the distal end. The suction port in such embodiments can be a single slot or a plurality of slots (e.g., as shown in FIGS. 2A and 2B), the variety of which can be advantageously designed based on the size, shape and mass of the subject fabric parts. Additionally, embodiments varying the shape (e.g., employing rectangular, triangular, segmented, slotted, circular, irregular, spiralized, or helical shapes) of the vacuum port are contemplated within the scope of the subject invention.

In contrast to related art systems, embodiments of the subject invention provide a simply supported roller without the need of a yoke frame or gantry and with sufficiently strong bearing support of the roller on one end. The rotor actuated by a motor via a belt and pulley torque transmission, and the roller supported by a non-rotatable fixed shaft. Embodiments provide two or more ball bearing (alternatively, bushings, sleeves, needle bearings, cartridge bearings, or other rotatable supports as known in the art) that are supported at two or more locations, either adjacent or spaced apart, along the length of the roller. Alternate embodiments provide sufficient support via a single ball bearing (alternatively, a single bushing, sleeve, needle bearing, cartridge bearing, or other rotatable support as known in the art) at a single location, optionally at one end or on one side of the roller (alternatively at the center, in the middle third, or distributed along the roller.)

### BRIEF DESCRIPTION OF THE DRAWINGS

FIG. 1 shows an example of a tension control block diagram for a dual-manipulator system according to an embodiment of the subject invention;

FIG. 2A shows side views of four rollers, each respectively having: a straight slot (top), separated slots (second from top), a tapered slot (second from bottom), and separated and tapered slots (bottom) according to an embodiment of the subject invention;

FIG. 2B shows perspective views of four rollers, each respectively having: a straight slot (top-left), separated slots (bottom-left), a tapered slot (top-right), and separated and tapered slots (bottom-right) according to an embodiment of the subject invention;

FIG. 3A shows a front view of an end effector with cut-line A-A for the partial section of FIG. 3C, according to an embodiment of the subject invention;

FIG. 3B shows a side view of a roller shaft with a slot for suction air flow to a vacuum source, according to an embodiment of the subject invention;

FIG. 3C shows a partial cross section diagram along section cut line A-A of the end-effector of FIG. 3A, according to an embodiment of the subject invention;

FIG. 3D shows a side view of an end effector, according to an embodiment of the subject invention;

FIGS. 4A-4I show a sequence of fabric handling operations using a single-manipulator system according to an embodiment of the subject invention, where the poses of the grasped fabric part can be precisely positioned using visual information acquired by a vision sensor system;

FIGS. 5A-5D show a fabric rolling-up operation using a single-manipulator system with synchronized motions of the roller and the end-effector to remove a wrinkle or slack in a target fabric according to an embodiment of the subject invention;

FIGS. 6A-6J show a sequence of fabric handling operations using a dual-manipulator system according to an embodiment of the subject invention, where (1) the robot system consists of two robot manipulators equipped with force sensors and rolling-up end-effectors, and a vision sensor system, (2) the dual-manipulator system handles a fabric part or multiple fabric parts by grasping it or them with the end-effectors, (3) the force sensors are used to control the tension applied to the grasped fabric part and keep it flattened, and (4) the poses of the grasped fabric part can be precisely positioned using the visual information acquired by the vision sensor system;

FIGS. 7A-7D show an end effector according to another embodiment of the subject invention; and FIGS. 8A-8J show a sequence of fabric handling operations using a dual-manipulator system according to the embodiment shown in FIGS. 7A-7D.

### DETAILED DESCRIPTION OF THE INVENTION

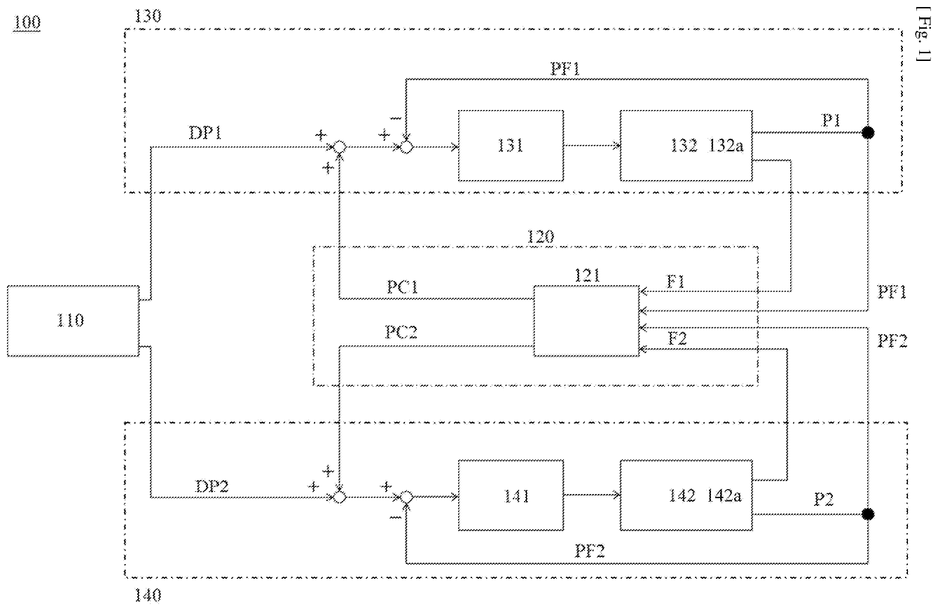

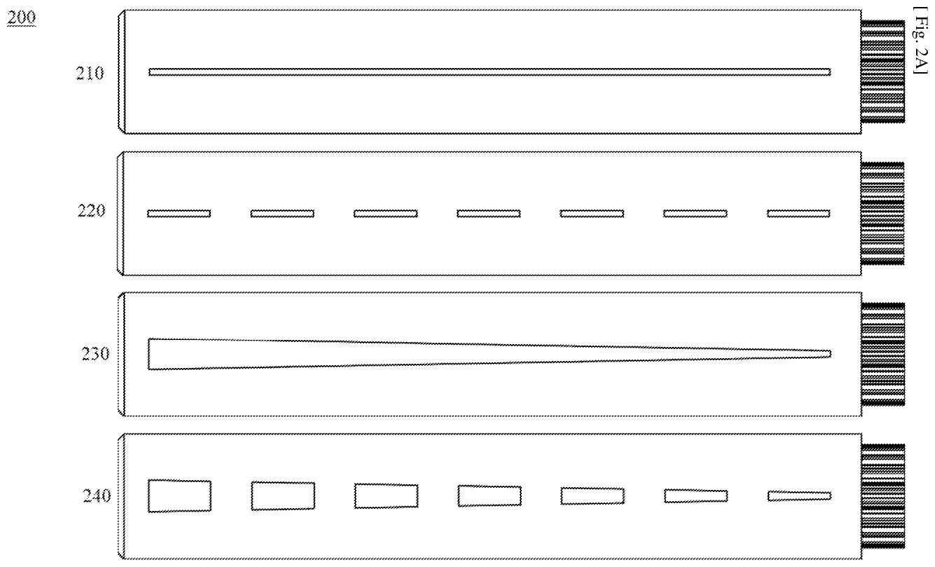

FIG. 1 shows a block diagram of a tension control 100 for a dual-manipulator system according to an embodiment of the subject invention. Trajectory generator 110 is connected to both force feedback module 120, and first and second manipulator controller modules, 130 and 140, respectively. Trajectory generator 110 sends out desired position signals DP1 and DP2. Force feedback module 120 sends out positional command signals PC1 and PC2, respectively. First and second manipulator controller modules, 130 and 140, respectively, send out first and second position feedback signals PF1 and PF2, as well as first and second force feedback signals F1 and F2, respectively.

Within the force feedback module 120, tension controller 121 takes in F1, PF1, F2, and PF2, respectively, and sends out PC1 and PC2, respectively. Within the first manipulator controller module 130, a controller 131 takes in the combined signal of (DP1+PC1−PF1) and generates a control signal to manipulator 132 with force sensor 132a. Within second manipulator controller module 140, a controller 141 takes in the combined signal of (DP2+PC2−PF2) and generates a control signal to manipulator 142 with force sensor 142a. This embodiment provides coordinated control of force and position allowing both manipulators to work in concert to control position and tension in a subject fabric.

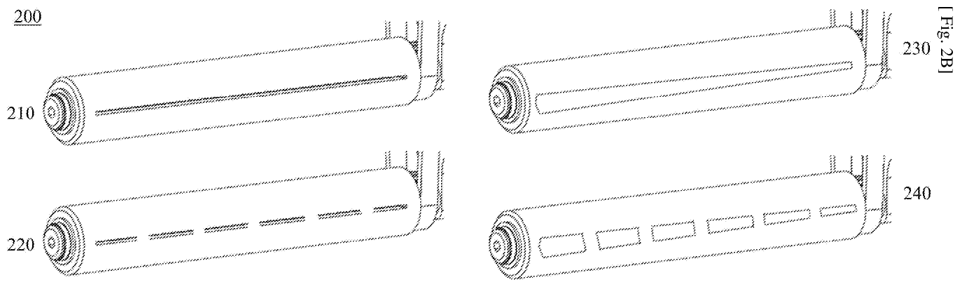

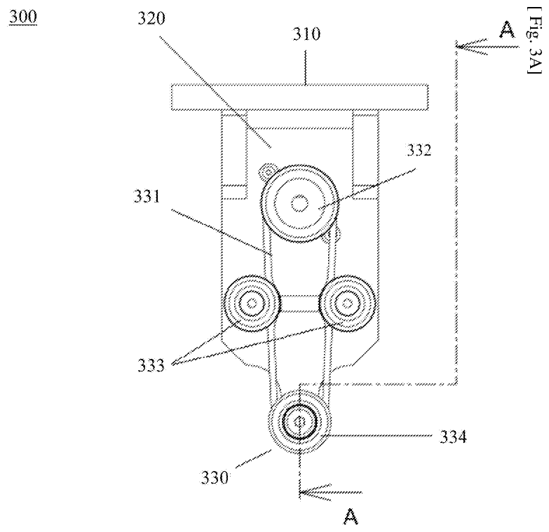

Although not shown in this embodiment, alternative embodiments can include a third, fourth, or additional manipulator controller modules analogous to replicating either module 130, module 140, or both, with all associated components, connections, signals, and functions (e.g., duplicating DP1, PC1, PF1, 131, 132, 132a, P1, PF1, F1, and all required connections in FIG. 1.) A set of end-effectors 200 according to embodiments of the subject invention is shown in FIGS. 2A and 2B. The end-effector can have a roller unit with a suction port open to the roller surface. A motor can be installed on the end-effector and the motor torque can be transmitted to the roller to control the rotation through a suitable transmission mechanism such as gears, pulleys, and belts. Shown are an end effector 210 with a single slot with uniform width vacuum port, an end effector 220 with a separated slot with uniform width vacuum port, an end effector 230 with a single slot with variable width vacuum port, and an end effector 240 with a separated slot with variable width vacuum port.

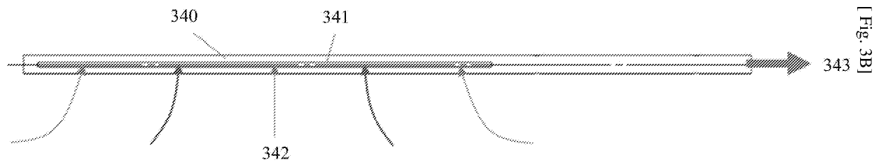

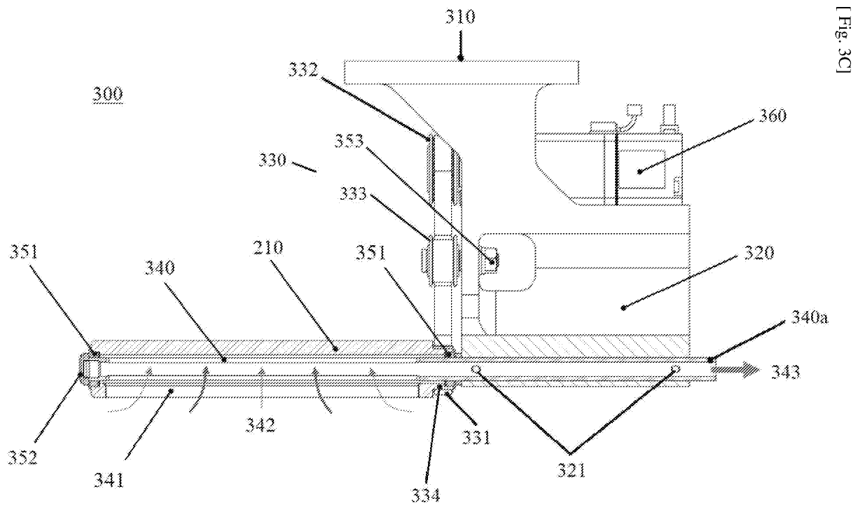

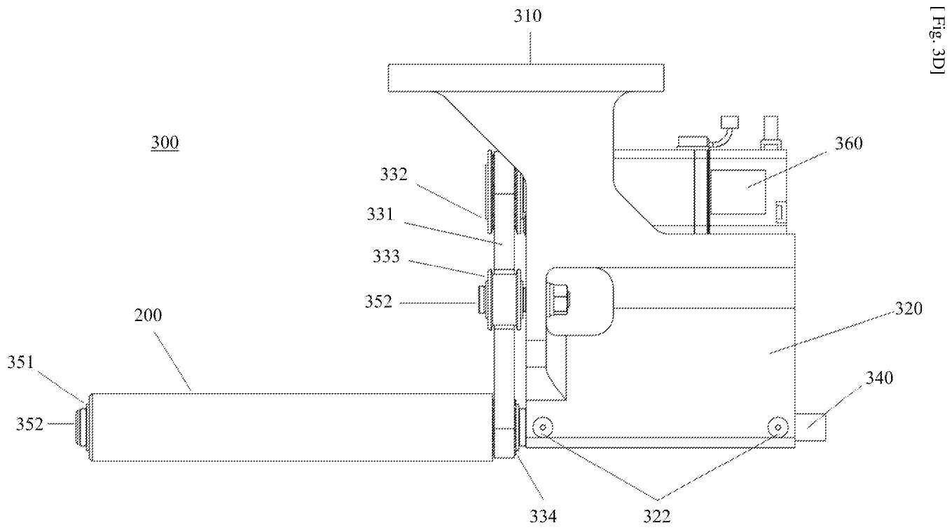

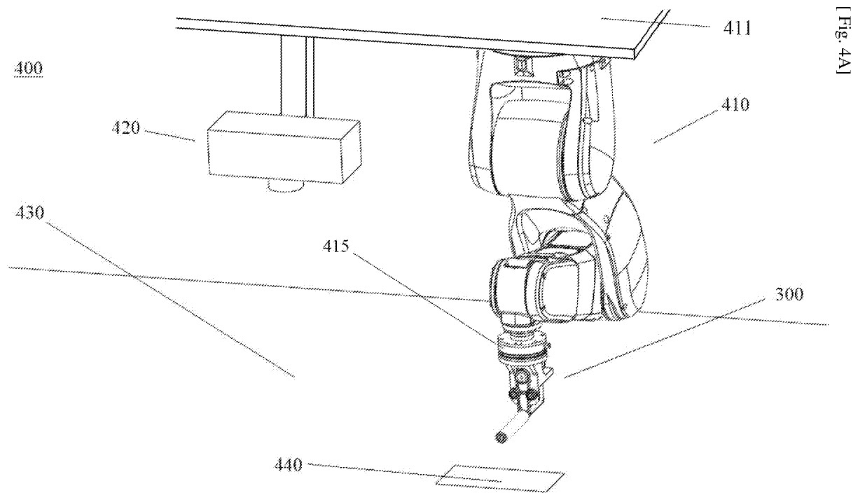

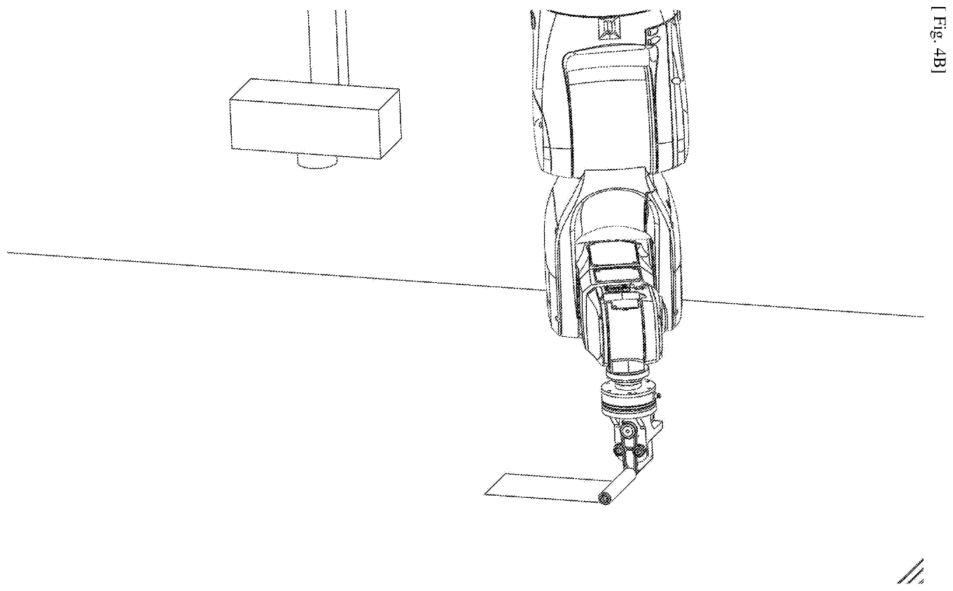

FIG. 3A shows a front view of an end effector 300 with cut-line A-A for the partial section of FIG. 3C, according to an embodiment of the subject invention. In this embodiment, mounting flange 310 is above main body 320, which supports drive system 330, including motor pulley 332, idler pulleys 333, shaft pulley 334, and drive belt 331.

FIG. 3B shows a side view of a roller shaft 340 with a slot 341 for suction air flow 342 to a vacuum source 343, according to an embodiment of the subject invention.

FIG. 3C shows a partial cross section diagram along section cut line A-A of the end-effector 300 of FIG. 3A, according to an embodiment of the subject invention. In this embodiment, mounting flange 310 is above main body 320, which supports motor 360, roller shaft 340, and drive system 330, including motor pulley 332, idler pulleys 333, fasteners 353, shaft pulley 334, and drive belt 331. Mounting holes 321 are used in certain embodiments to attach, secure, or orient roller shaft 340 to body 320 (e.g., by cross-pinning or fastening within a bore in body 320). Roller shaft 340 is configured and adapted to deliver air to vacuum source 343 at proximal end 340a. Roller unit 210 is supported on bearings 351 and secured in place by fastener 352.

FIG. 3D shows a side view (without section) of an end effector 300, according to an embodiment of the subject invention. In this embodiment, optional fasteners 322 are visible, securing roller shaft 340 in body 320.

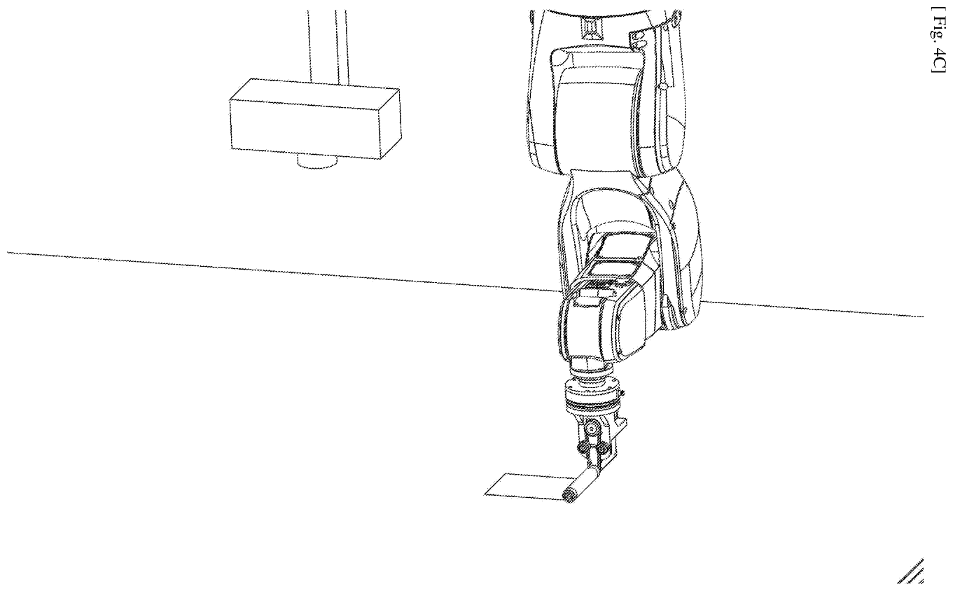

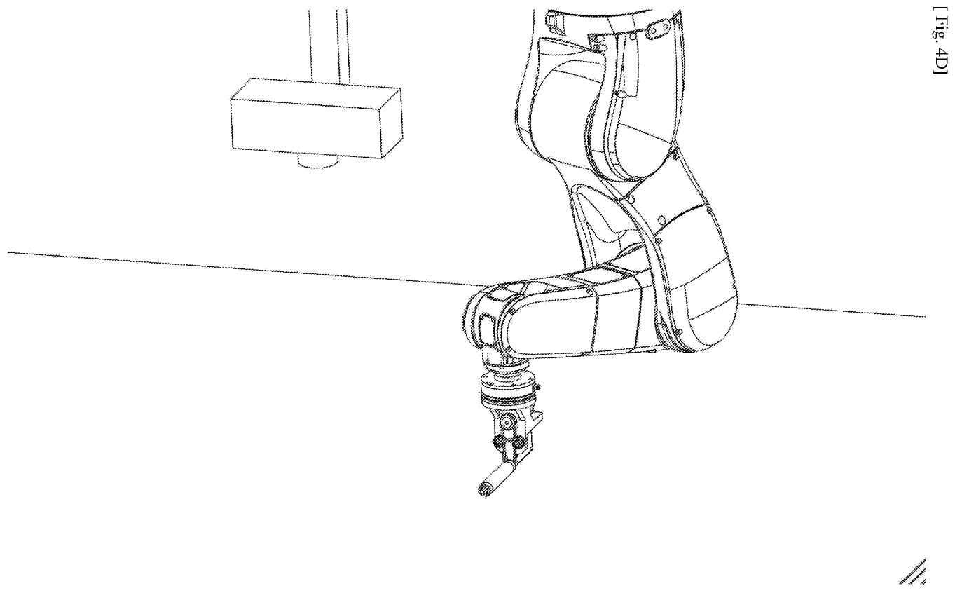

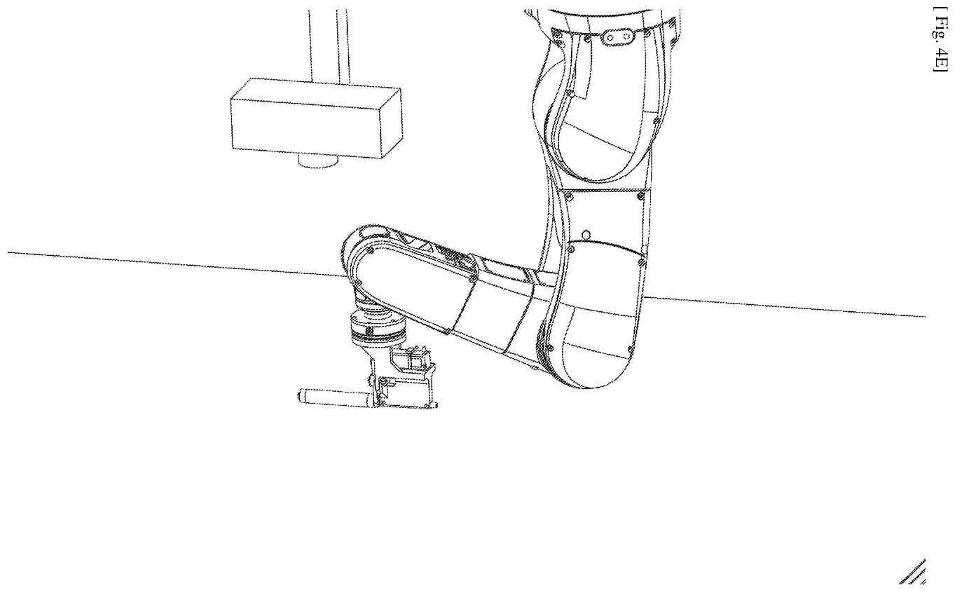

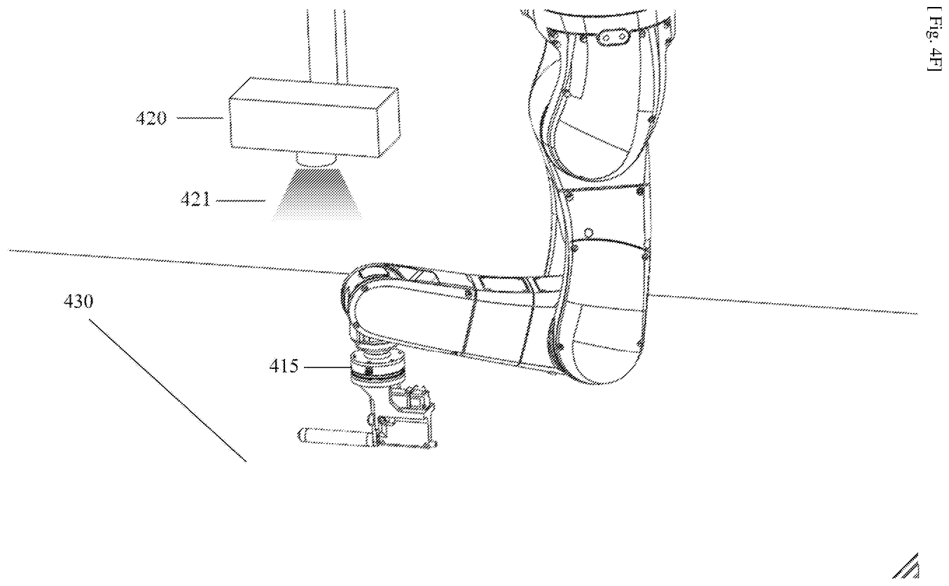

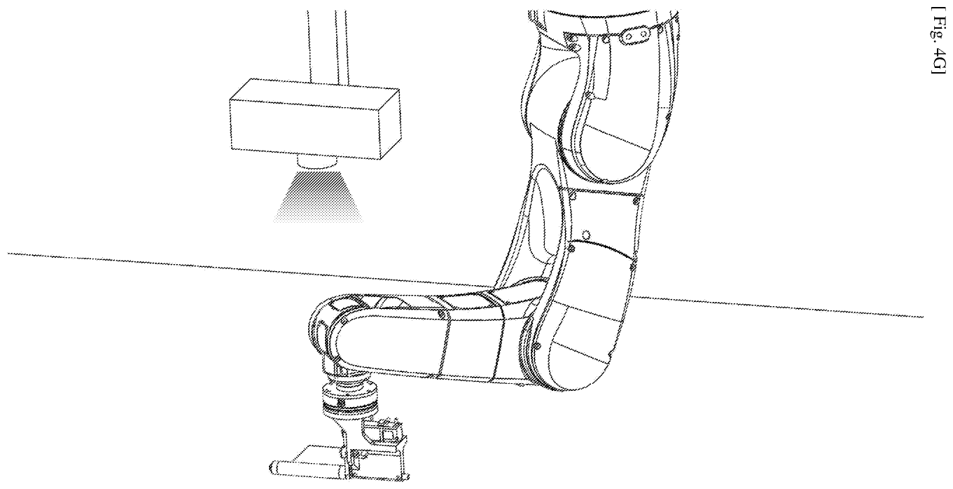

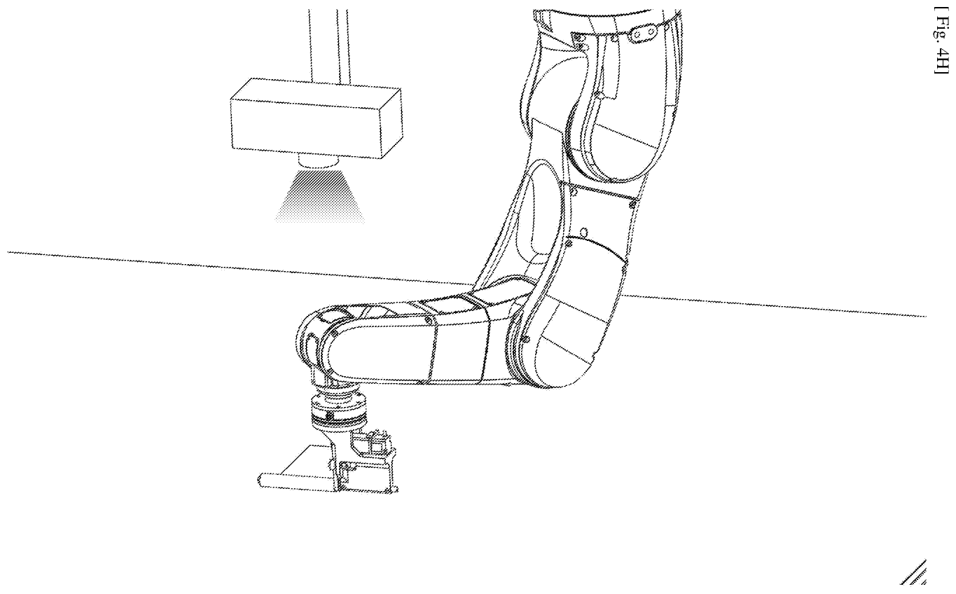

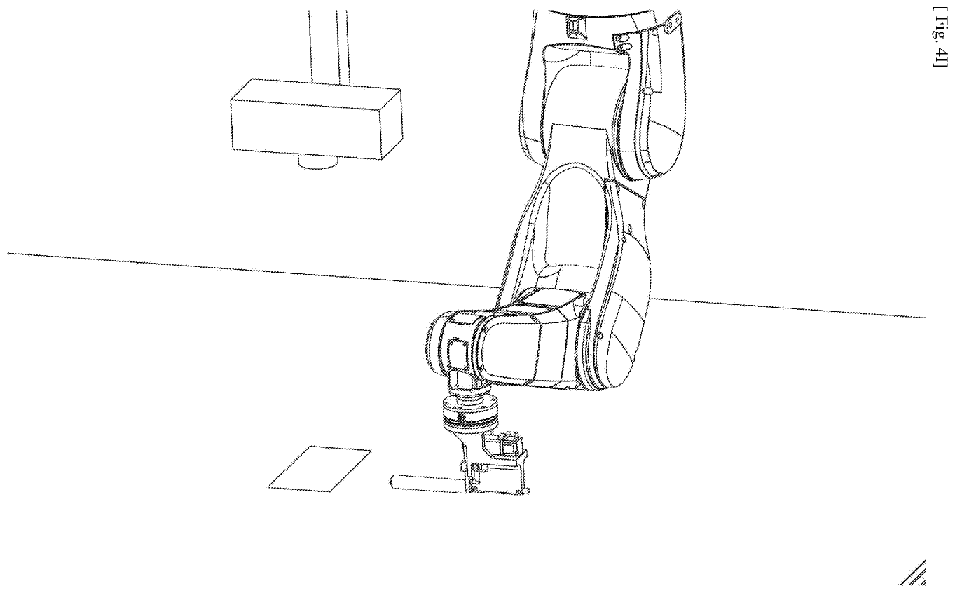

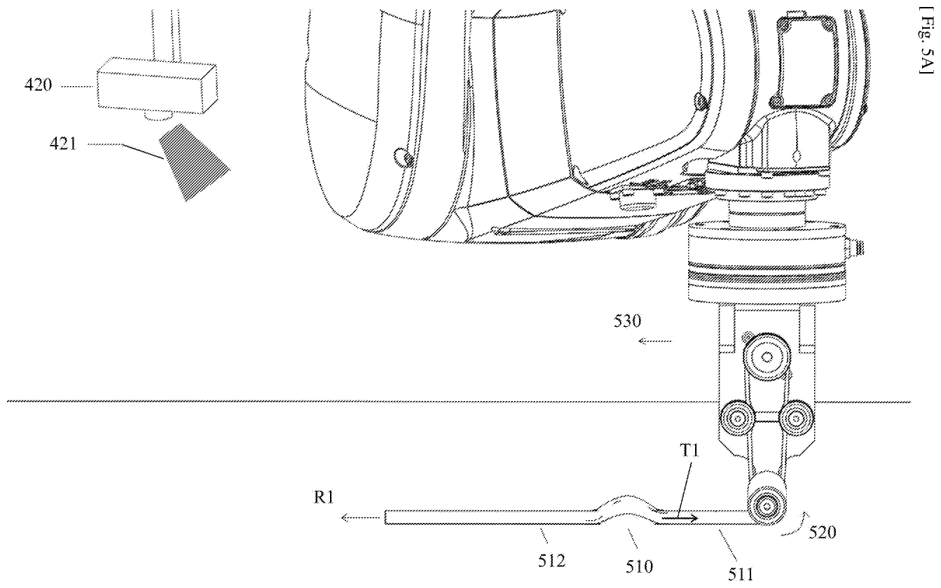

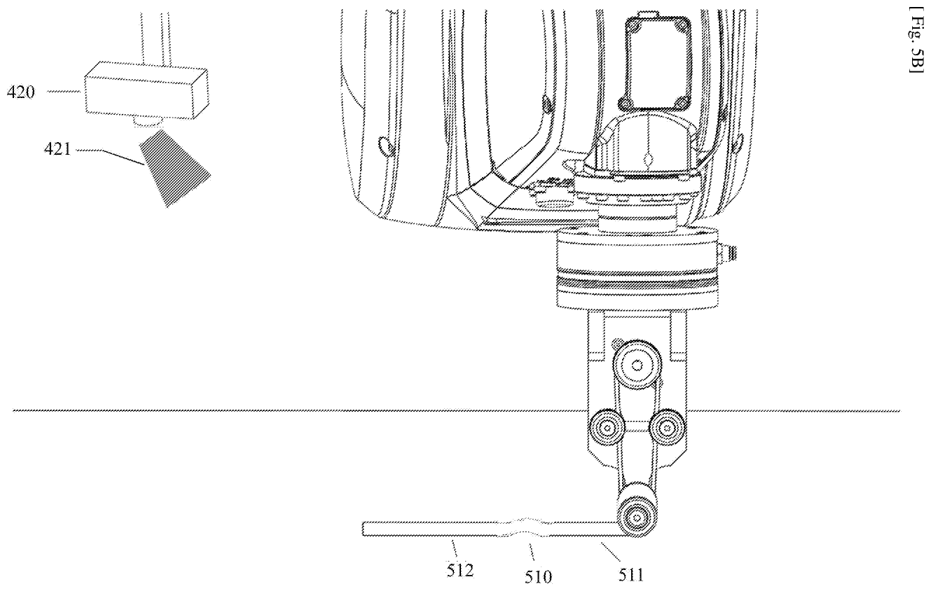

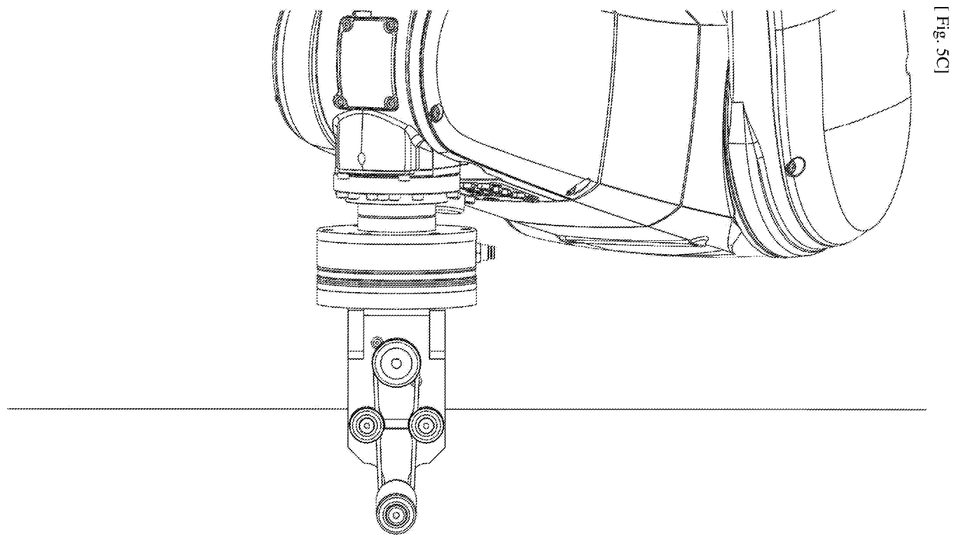

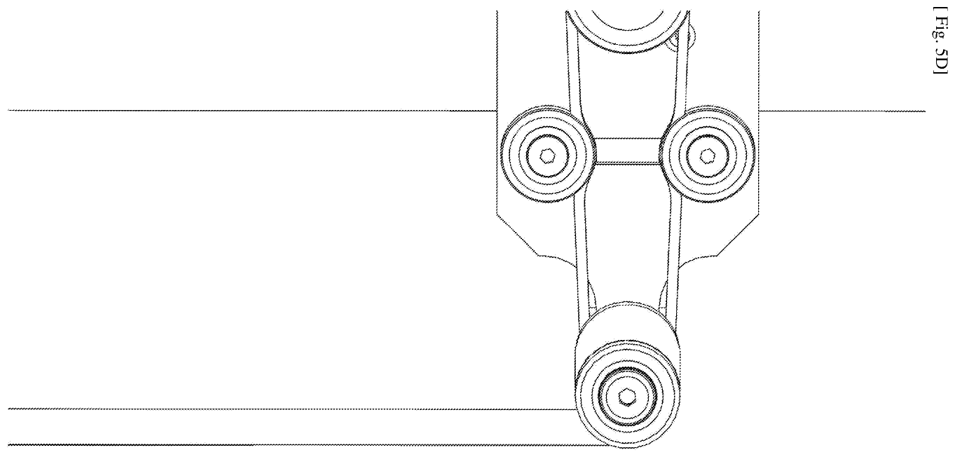

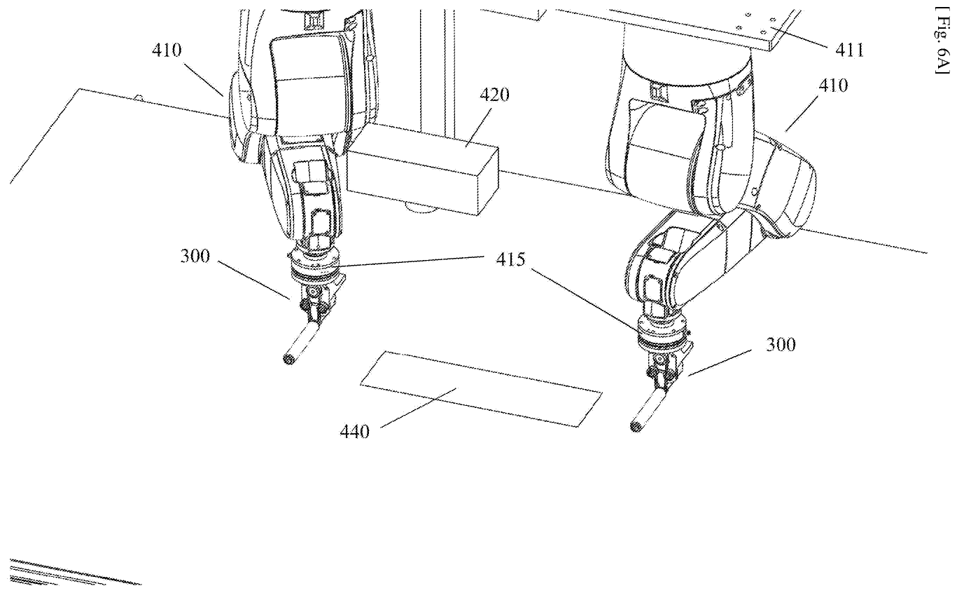

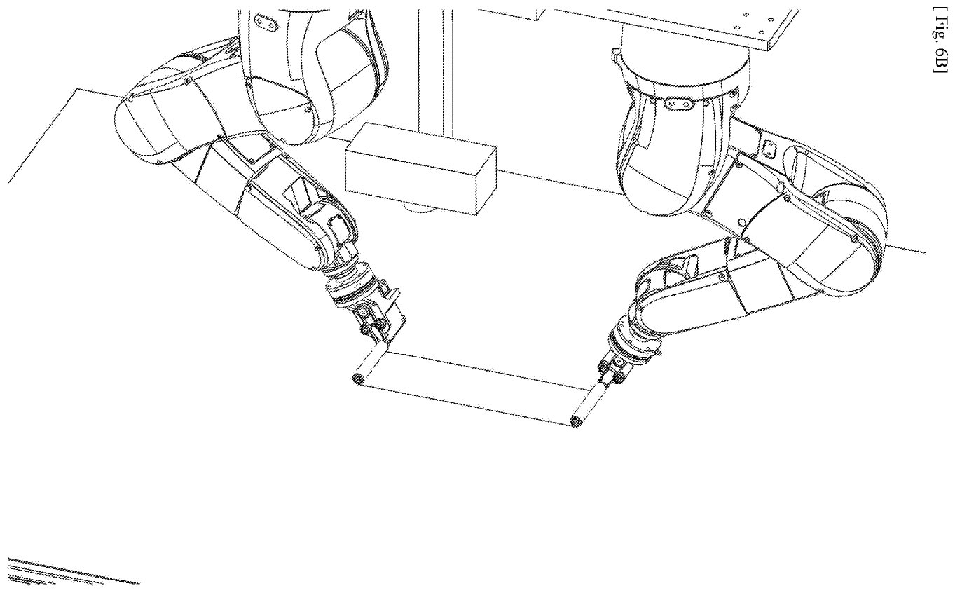

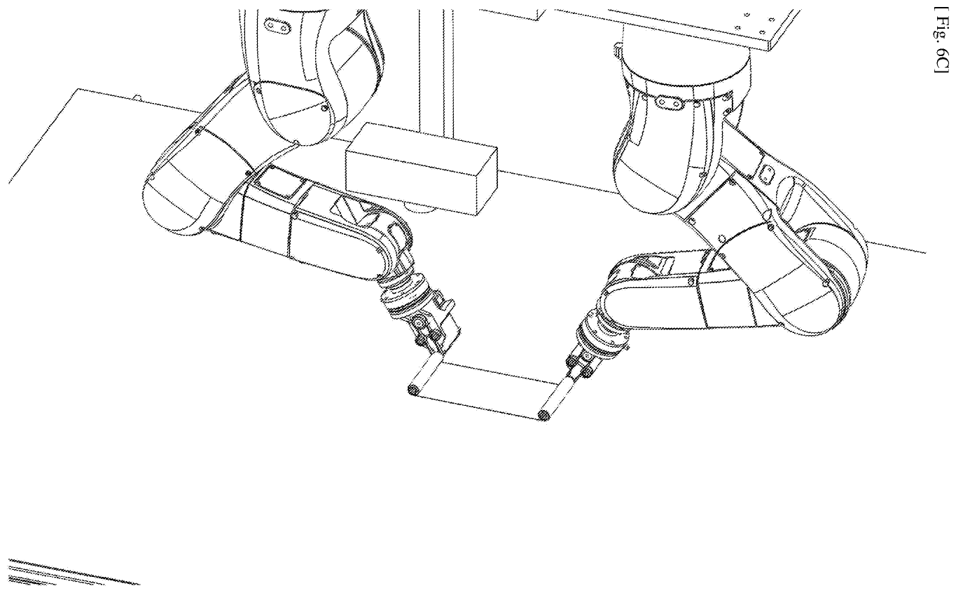

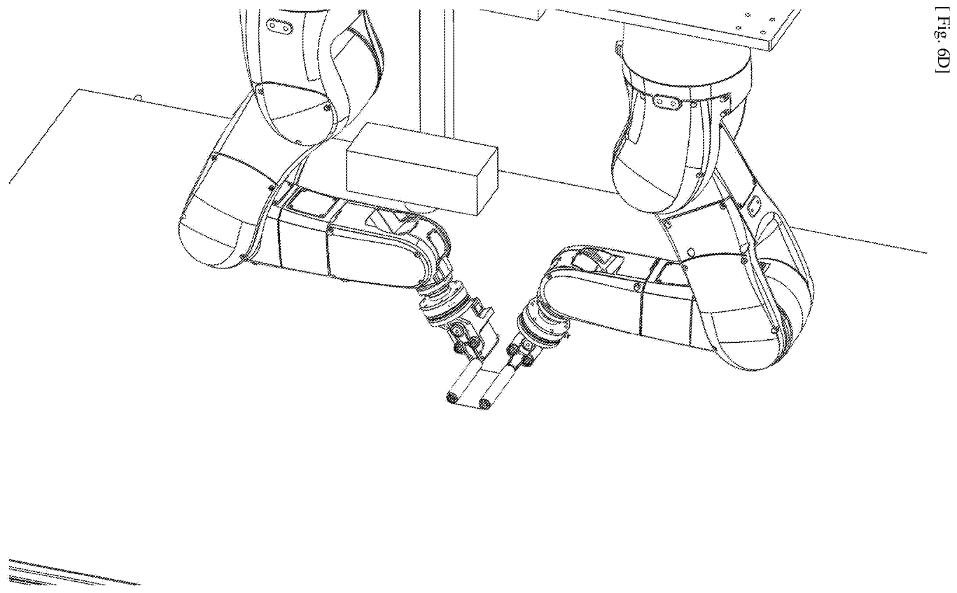

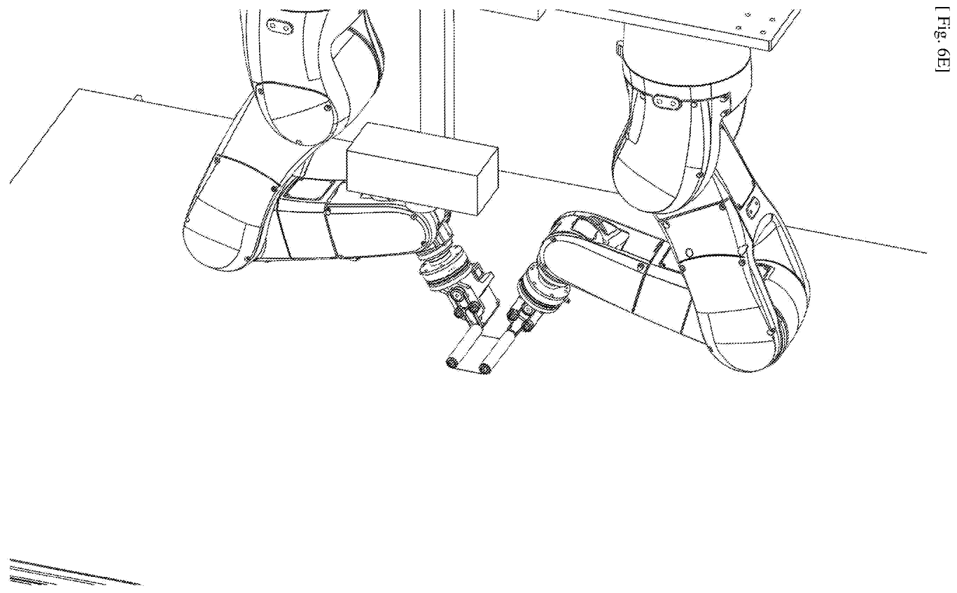

FIGS. 4A-4I show an example of a robotic manipulator system 400 according to an embodiment of the subject invention to illustrate a process or sequence of steps useful to acquire, transfer, and position a fabric part placed on the worktable using a single manipulator according to an embodiment of the subject invention. Robotic arm 410 supported by frame 411 and equipped with a force (or torque) sensor 415 moves end effector 300 under optional feedback from camera or sensor 420 to interact with target fabric 440 on work surface 430. To begin with, the end-effector is moved by the manipulator such that the suction port comes into contact with one end of the fabric part (FIG. 4B). The contact force is monitored and regulated using the force sensor 415. The suction port acts to hold the contacted area of the fabric part by applying a suitable negative pressure or vacuum. The roller rotates to roll up the fabric part while maintaining the suction, and meanwhile the manipulator translationally moves the end-effector in a direction and with a controllable displacement that accommodates the rolled-up portion without perturbating (e.g. wrinkling, slacking, sliding, twisting, or buckling) the rest of the fabric (e.g., as illustrated in FIGS. 5A-5D).

FIGS. 5A-5D show a fabric rolling-up operation using a single-manipulator system with synchronized motions of the roller and the end-effector to remove a wrinkle or slack in a target fabric according to an embodiment of the subject invention. In certain embodiments the manipulator motion 530 and the roller rotation 520 can be synchronized in such a way that certain wrinkles or slacks of the fabric are prevented, inhibited, removed, or reduced during the rolling-up operation. For example, camera 420 can, within its field of vision 421, be configured and adapted to detect a wrinkle or slack 510 in a target fabric. Motion 530 and rotation 520 can be controlled to produce a tension T1 in a first section 511 of the target fabric on a proximal side of a wrinkle or slack 510. Tension T1 and reaction R1 together form a pair of counteracting forces acting to straighten slack 510. The tension T1 is opposed by resistance R1 generated by interaction of a second section 512 of the target fabric on a distal side of the wrinkle or slack 510 with work surface 430, and the tension T1 can be controlled to manipulate the target fabric and reduce, remove, or manipulate the wrinkle or slack 510.

After the fabric part is rolled up by an appropriate amount (e.g., as shown in FIG. 4D), the manipulator moves the end-effector to a target position (e.g., as shown in FIG. 4E-F). Camera 420 can provide feedback over field of vision 421 to improve control of the end-effector. The force of contact against the work surface 430 is monitored and regulated using the force sensor 415. The end-effector finally spreads the rolled-up fabric part with the roller rotating in a reverse direction. The approach exemplified by FIGS. 5A-5D is then applied in an opposite manner such that the manipulator moves the end-effector to unroll and lay the fabric part flat using the visual information collected from the vision sensor system (FIG. 4G-I).

In certain embodiments, the vision sensor system comprises a full color sensor (e.g., an RGB digital camera). Ancillary lighting can be included where necessary to improve the performance of the vision sensor system. Use of a monochrome camera is also contemplated and provides the benefits of reduced cost and complexity for reliable operation. A color or RGB camera beneficially captures more visual information and can determine the fabric pose more accurately (e.g., in cases where the subject fabric is colored).

By rolling up, the end-effector can grasp fabrics according to various embodiments of the subject invention with a certain range of different dimensions, e.g. those that satisfy one or more of the following conditions: (i) the maximum fabric width is less than the length of the roller; and (ii) the manipulator's motion range covers the fabric length during the operation. Embodiments of the subject invention can be advantageously applied to thin and soft fabric materials that can readily deform to comply with the shape of the roller. Certain embodiments of the system can allow the end-effector to reversibly change the grasped fabrics between flattened and rolled-up configurations as and when necessary (e.g., the target fabric shown in FIG. 5A has a wrinkle or slack removed or reduced in FIG. 5B, is rolled up in FIG. 5C and then returned to a flattened configuration, with optional changes in position and orientation, in FIG. 5D).

Embodiments providing a single-manipulator robot can handle fabric using a single end-effector and simplified tension control, as exemplified above. Alternative embodiments of the invention provide a robot comprising two manipulators (i.e. dual-manipulator system) each with at least one force (or torque) sensor and an end-effector, which enable enhanced tension control. Further alternative embodiments of the invention provide a robot comprising three or more manipulators (i.e. multi-manipulator system), each with at least one force (or torque) sensor and an end-effector, which enable multi-dimensional tension control.

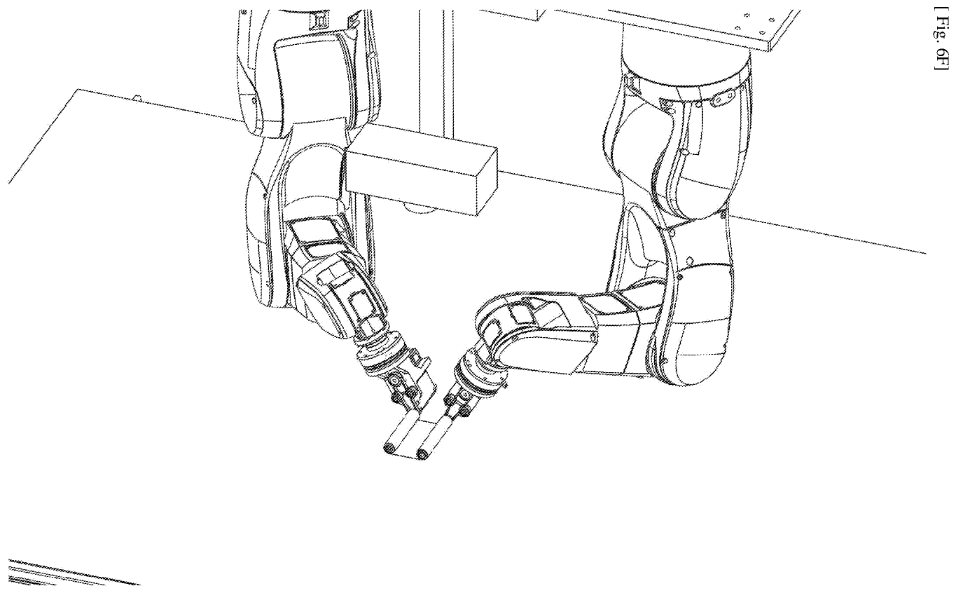

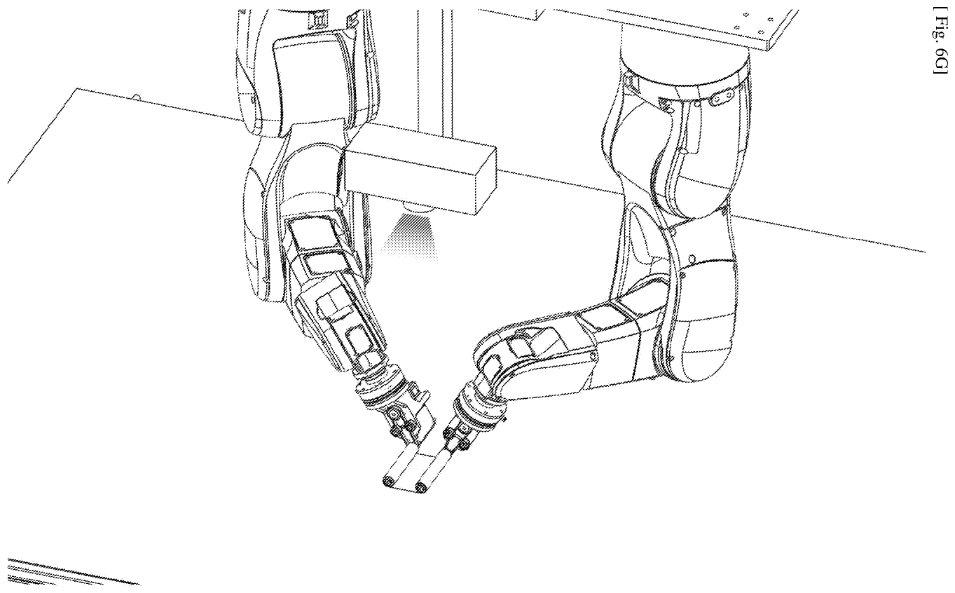

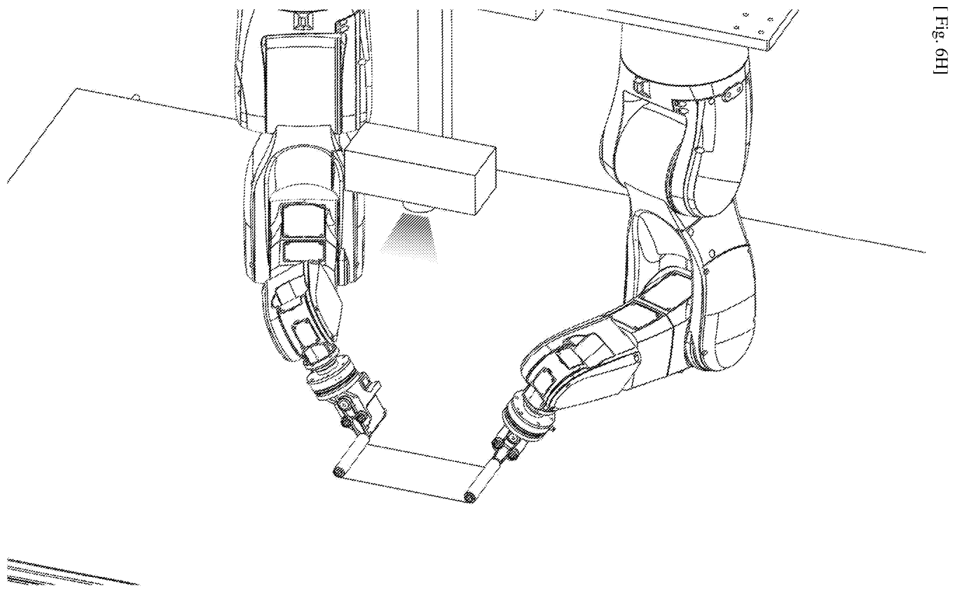

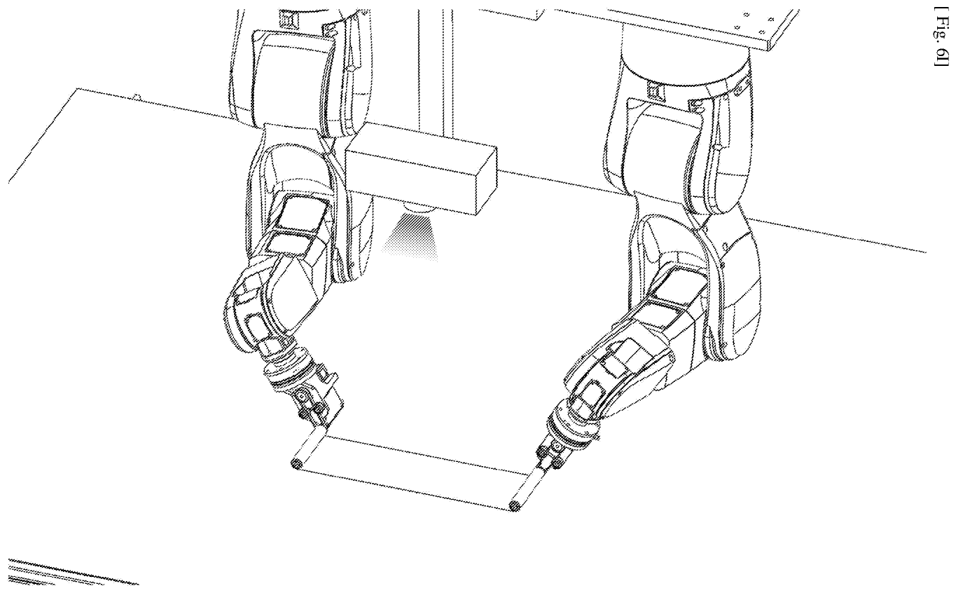

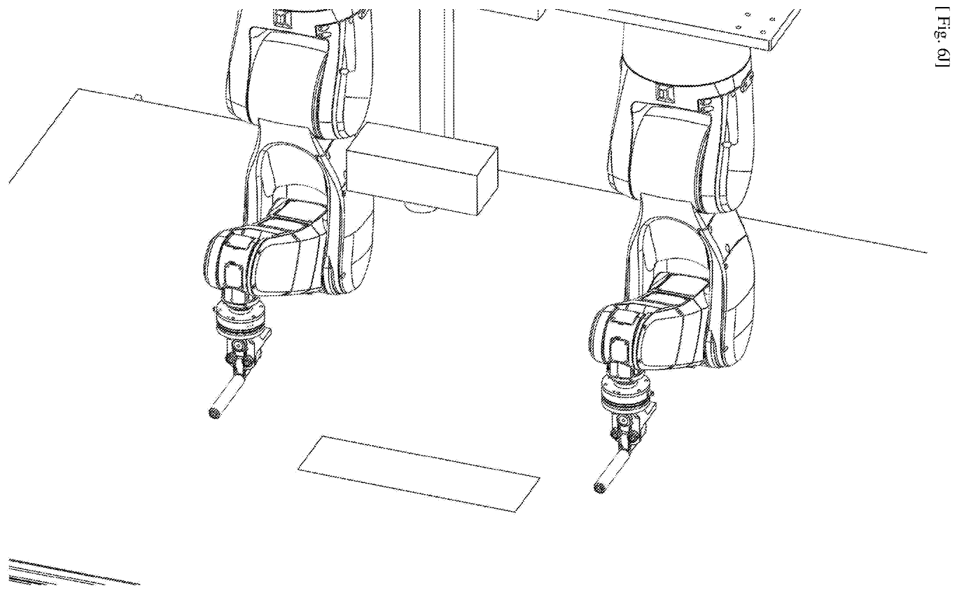

FIGS. 6A-6J illustrate a sequence to grasp, transfer, and position a fabric part placed on the worktable using a dual-manipulator system according to an embodiment of the subject invention. In this embodiment the end-effectors 300 with force sensors 415 can simultaneously (or in parallel, or synchronously, or asynchronously, or sequentially) roll up the fabric part 440 from both sides the same way as or in a manner similar to the aforementioned single-manipulator method (e.g., FIGS. 6B-D). The robot then lifts up the fabric and transfers it to a target location (e.g., FIGS. 6E-F). In the course of rolling-up, transporting, spreading, and positioning the fabric part, tension is applied to the fabric part and controlled using the force sensors 415 attached to the manipulators 410 (e.g., using the controller of FIG. 1) and supported by frame 411. Visual feedback with the vision sensor system 420 can also precisely position the grasped fabric part to the target pose (e.g., FIG. 6G-I). An advantageous feature of the provided dual-manipulator system is that it can grasp fabric parts by both sides and control the tension in between. To apply an appropriate tension to the grasped fabric part, the system can keep it flattened and precisely position it even if the fabric part is subjected to other external forces, such as disturbances arising from sewing operations.

The combination of the dual-manipulator configuration, the provided end-effector and force sensor, the tension control, and the vision-based position control enables precise handling of fabric parts of different shapes without using fixtures.

In a garment factory, fabric parts are usually cut from a stack of fabric materials using a cutting machine according to the shapes defined by preset patterns. Picking up the topmost fabric piece from a stack of cut fabrics can be difficult especially when implemented by automation facilities such as a gripper. First, the weight of the stack can cause the fabrics to compress and stick together, making it difficult to separate them. Second, the threads exposed at the cut edges of adjacent fabric pieces may become entangled during the cutting process, forming interlocks along the edges.

When more than one piece of fabric is (inadvertently) picked up by a gripper, the ensuing sewing operation will become erroneous and lead to a defective product. The ability to pick up “only one ply” remains a challenging task in the field of automated garment production.

While the above design has been shown to be effective in performing pick-and-place operations on standalone fabrics, it faced some challenges when used to pick up only the top-most fabric sheet from a pile, a case where two or more sheets of fabric may be unintentionally picked up at a time by the end-effector. The reason is that a fabric pile which is freshly cut (by factory cutting tools) may suffer from entanglement of fabric fibers and/or electrostatic effects which tend to “stick” together multiple sheets of fabric.

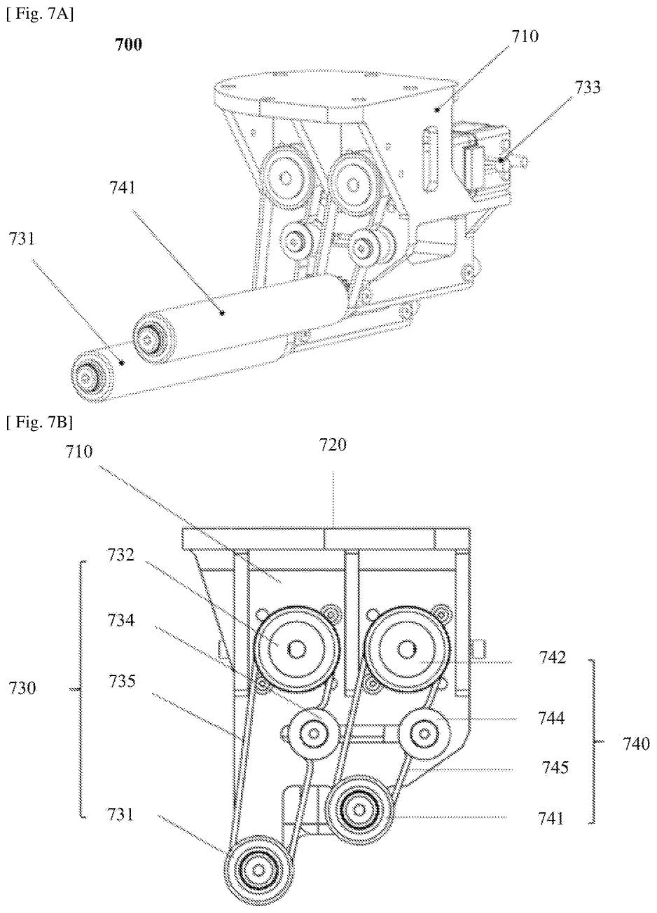

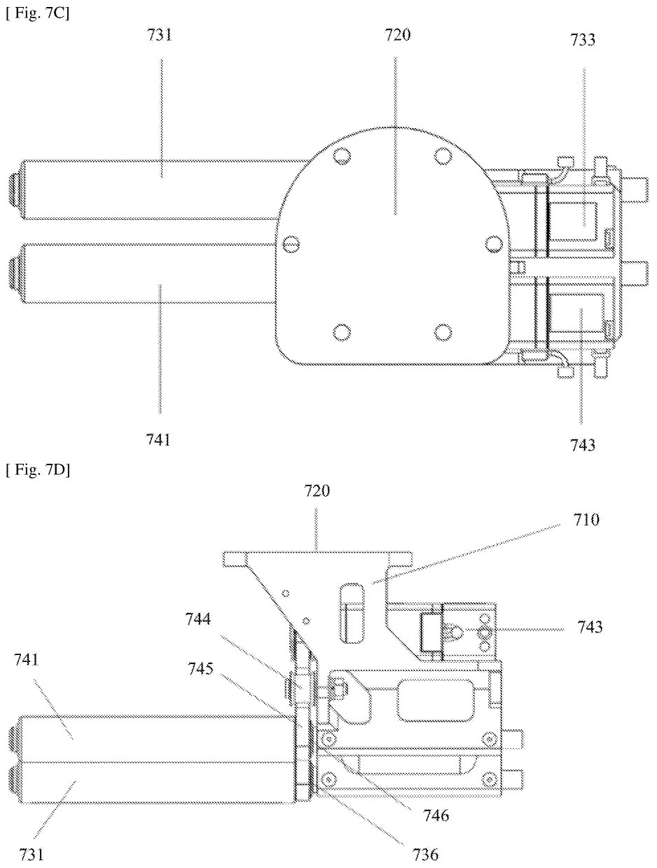

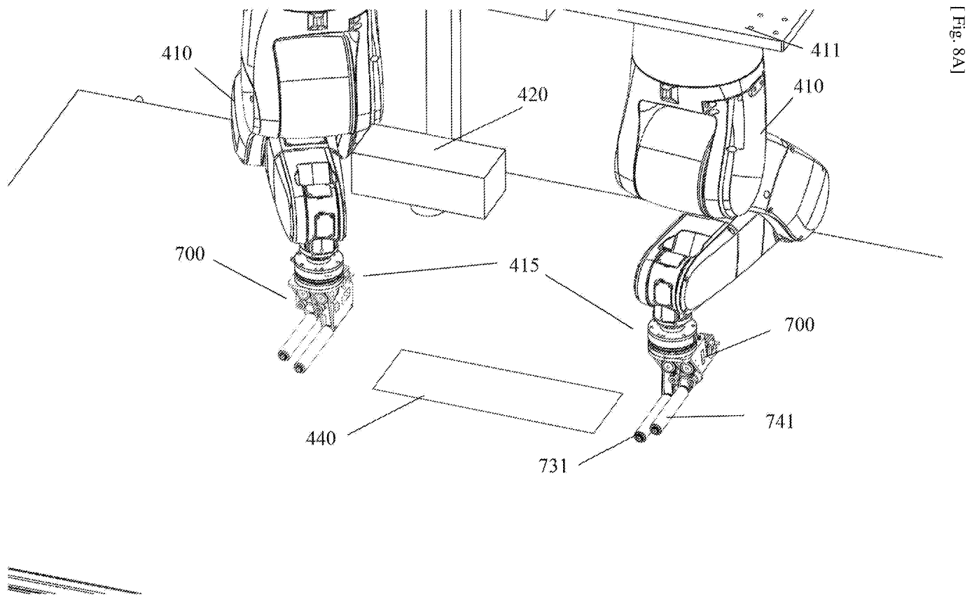

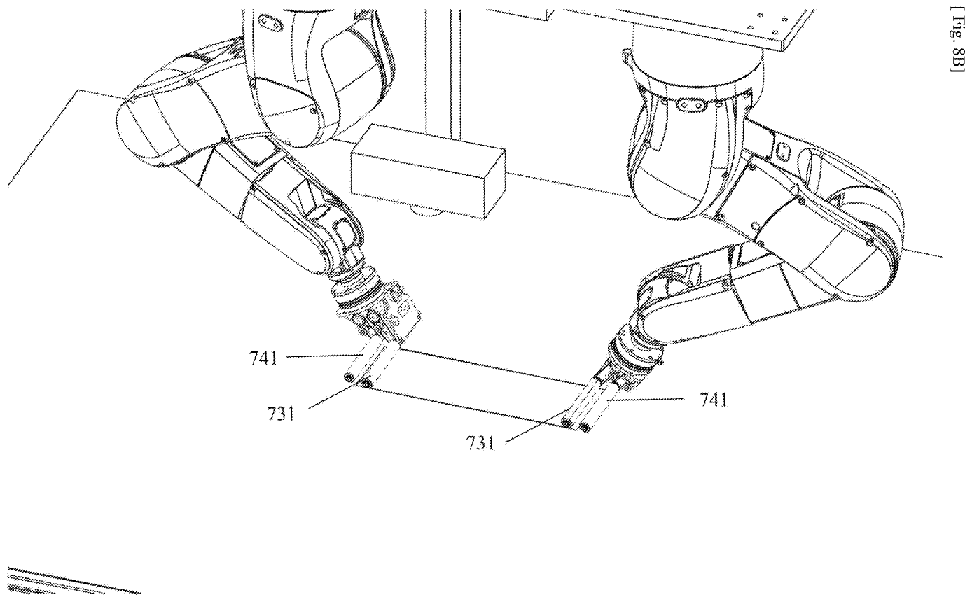

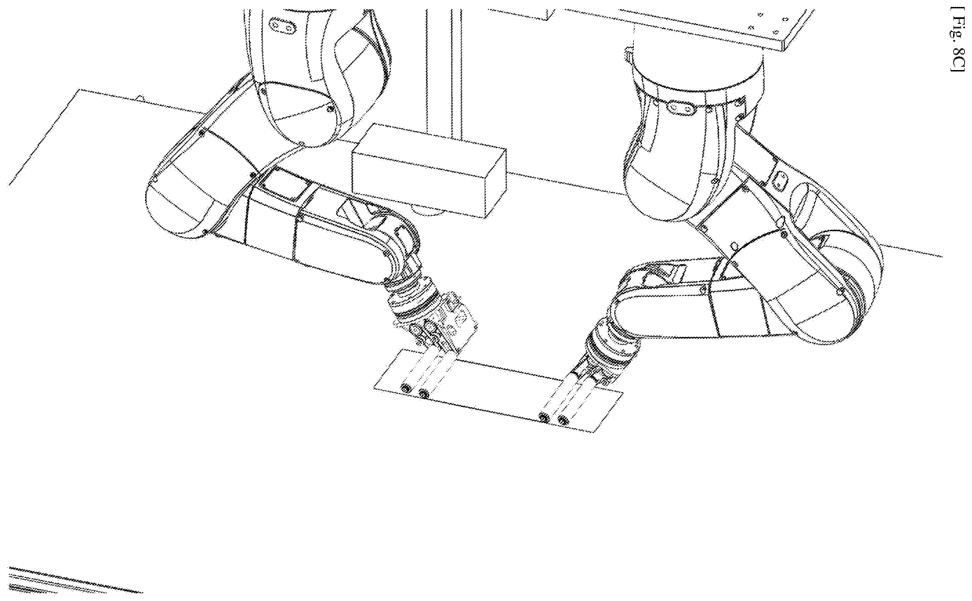

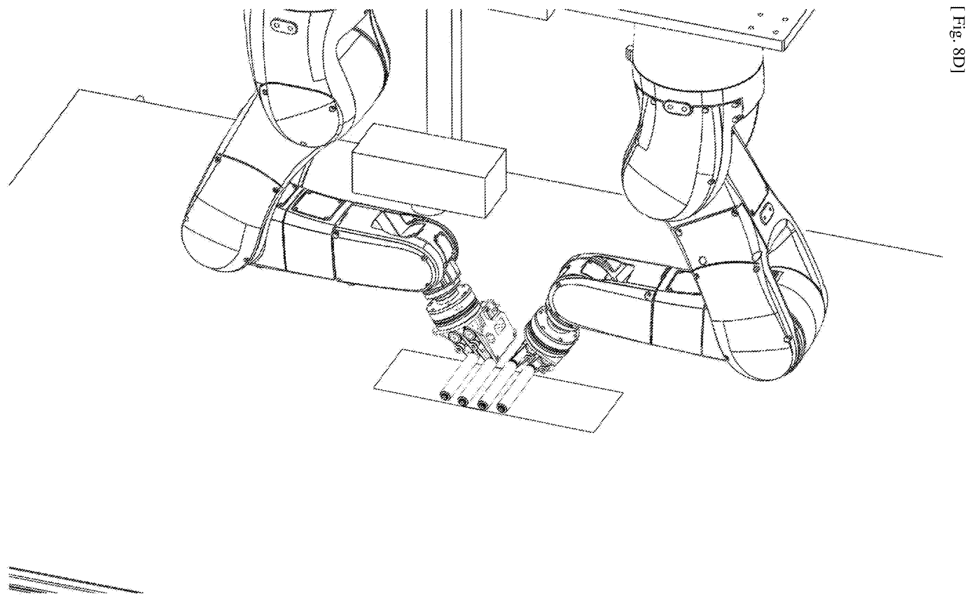

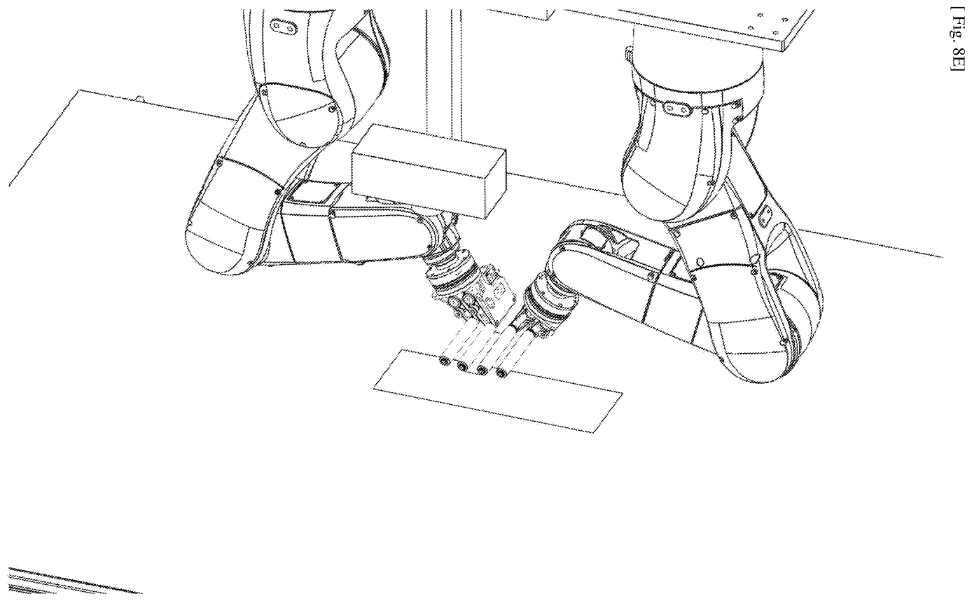

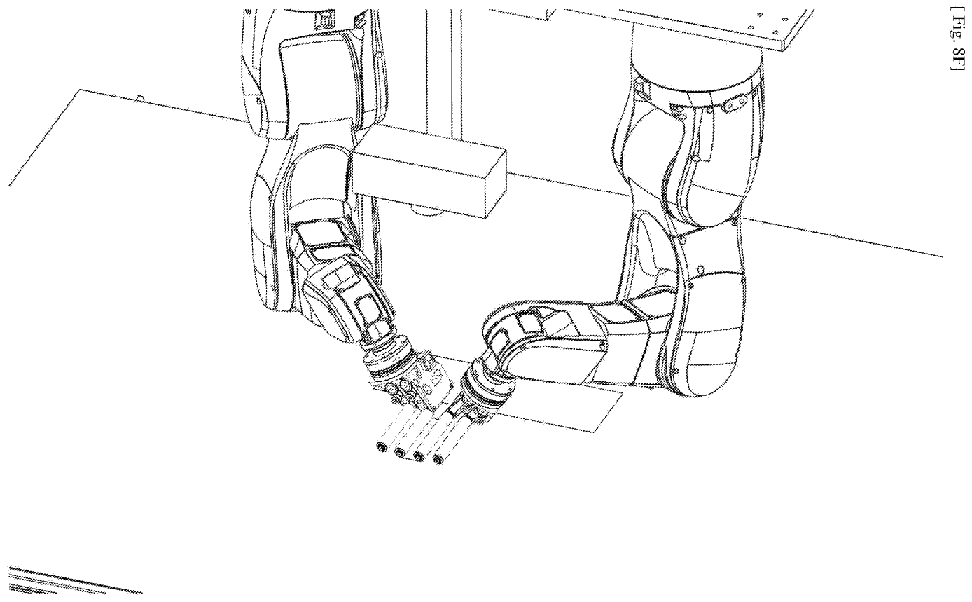

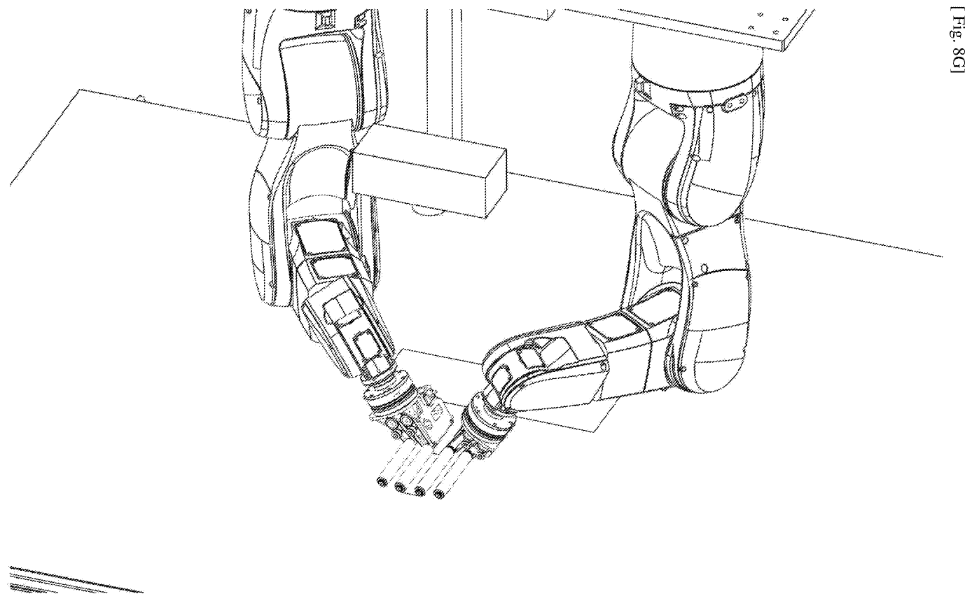

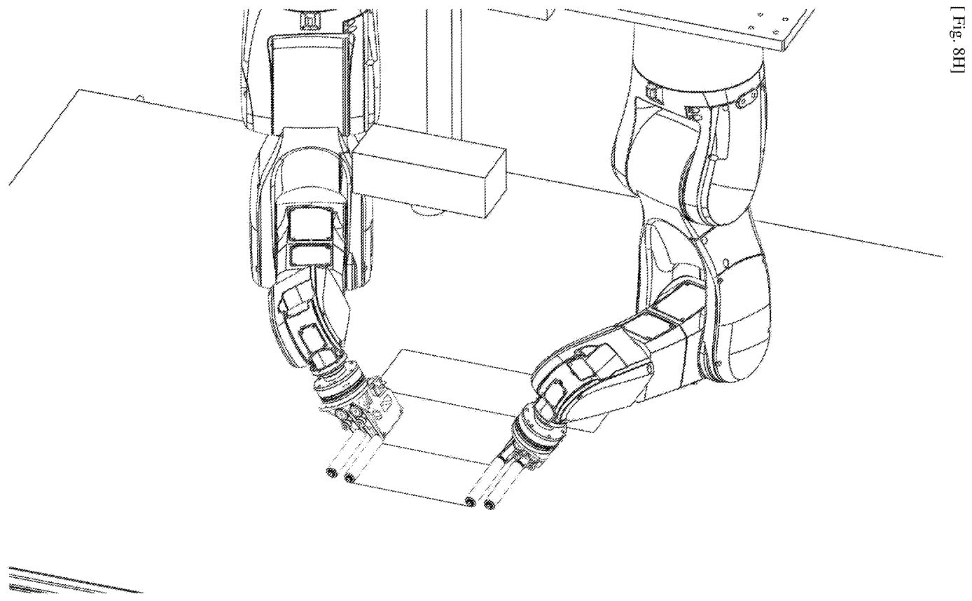

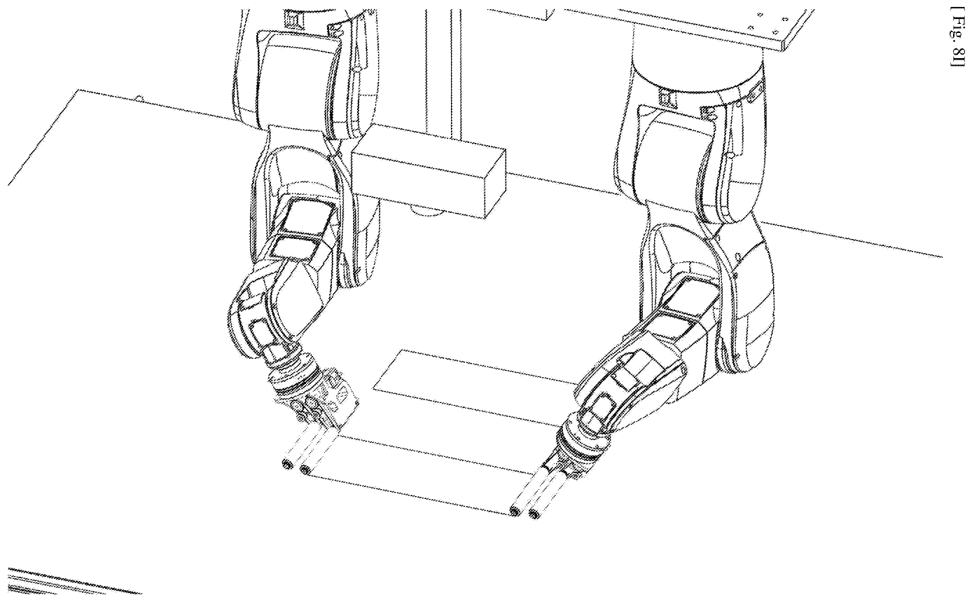

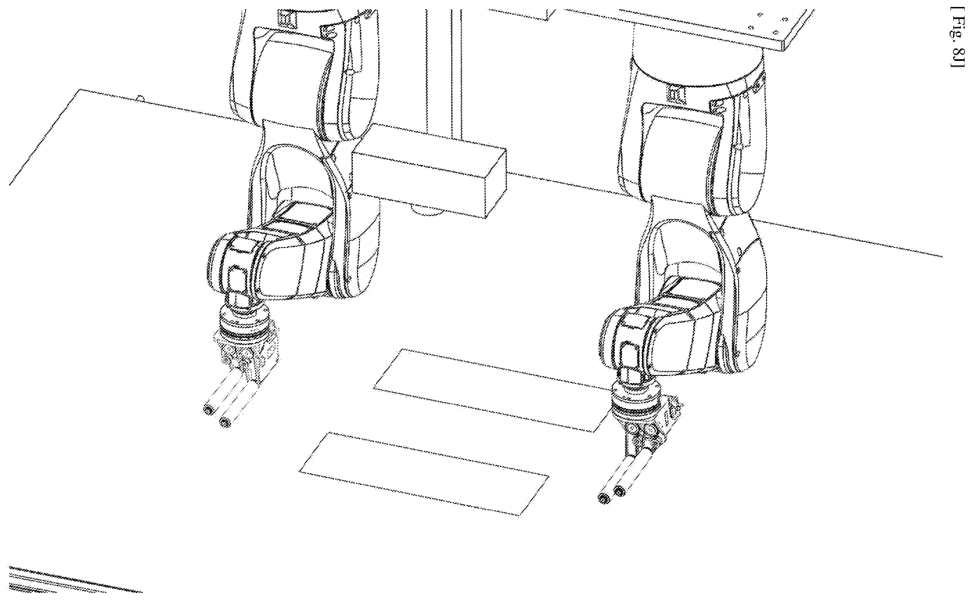

FIGS. 7A-7D show an end effector according to another embodiment by which the above problem can be solved. In the embodiment shown in FIGS. 7A-7D, on a side of the suction roller, an air-blowing unit 740 is provided. Although an air-blowing unit comprising an air-blowing roller 741 is shown in FIGS. 7A-7D, the subject invention is not limited thereto. Instead of an air-blowing roller, the air-blowing unit 740 may include a row of nozzles, a slit, a pipe, etc., through which air from a source of positive pressure can be blown out. Hereinafter, the embodiment will be described by the example of an air-blowing roller 741.

As shown in FIGS. 7A to 7D, which show a perspective view of the end effector 700, the end effector 700 includes a main body 710 above which is provided a mounting flange 720 configured to mount the end effector 700 to the robotic arm (not shown). On the main body 710, a drive system 730 for driving the suction roller 731 is provided. The drive system 730, similar to that shown in FIG. 3 to FIG. 5, includes a motor pulley 732 driven by a motor 733, an idler pulley 734, a drive belt 735 and a shaft pulley 736 which is connected with the suction roller 731. Thus, the suction roller 731 can be rotated by the motor 733 via the drive belt 735. The suction roller 731 can be the same as the suction roller 340 as shown in FIG. 3 so as to pick up the fabric sheet, thus the suction roller will not be described in detail.

On the main body 710, an air-blowing unit 740 is provided to blow air in a selectable direction. The air-blowing unit 740 includes an air-blowing roller 741 provided at a side of the suction roller 731 and on the circumference of which at least one opening (not shown) is formed, through the opening, air can be blown out. The air-blowing unit 740 further includes a motor pulley 742 rotated by a motor 743, an idler pulley 744, a drive belt 745 and a shaft pulley 746 connected with the air-blowing roller 741. The opening on the air-blowing roller can be a row of apertures or slits provided on the air-blowing roller so as to blow the air from e.g. an air source of positive pressure. In operation, the air-blowing roller can be rotated by the motor 743 via the drive belt 745 so as to change the direction in which the air is blown.

Hereinafter, the operation of the end effector 700 will be described with reference to FIG. 8A to FIG. 8J, it is noted that the operation shown in FIG. 8A to FIG. 8J is described as an example, and the present disclosure will not be limited thereto, and in the following, the end effector 700 will be described by the example in which two end effectors 700 are provided in mirror relationship and cooperate together, but the present disclosure is not limited thereto:
1. As shown from FIG. 8A to FIG. 8B, as the suction roller 731 comes into physical contact with the topmost sheet 440 of a fabric pile, the air-blowing roller 741 initiates an outbound airflow to induce vibratory motions (as mechanical disturbances) at the edges of the fabric sheets. Such motions act to disengage undesirable entanglements between adjacent fabric sheets caused by interlocking of dangling fibers at the cut edges.
2. By selecting a predetermined angle of airflow relative to the plane of fabrics, which can be determined empirically, the topmost sheet of fabric may readily be separated from the remaining sheets and be engaged by the suction roller.
3. The suction roller then captures the topmost sheet (or ply) of fabric by suction and performs the rolling action to acquire the sheet, as shown in FIG. 8C.
4. Meanwhile, the air-blowing roller rotates in such a way that the airflow is directed substantially towards the second sheet of fabric in the pile. The positive air pressure so generated stabilizes the second sheet and avoids it from being tracked/caught by the topmost sheet (e.g., due to entanglements in other locations) during the picking up process, as shown in FIG. 8D.
5. Once the entire top sheet is lifted up and detached from the fabric pile, the airflow of the air-blowing roller can be turned off, as shown in FIG. 8E.
6. The airflow may remain deactivated during the subsequent transfer and placing process, as shown in FIGS. 8F and 8G.
7. When the top sheet is moved to a predetermined target location, as shown in FIGS. 8H-8I, the top sheet will be gradually unrolled from the suction rollers.
8. As shown in FIG. 8J, when the top sheet is wholly unrolled from the suction rollers, the suction is turned off, and the top sheet is separated from the suction rollers.
9. The above cycle repeats as the end-effector fetches the next topmost sheet from the fabric pile.

Thus, by providing an air-blowing roller with the suction roller, the top piece of fabric can be easily and correctly picked up from a pile of the fabric material.

Similar with the previous embodiment shown in FIG. 6, two end effectors 700 can be provided, so as to pick up or roll up the fabric from both sides, to form a dual-manipulator system, so it will be not described here in detail.

Although the air-blowing roller is provided for blowing out air, other air blowing units can be conceived by the person skilled in the art. For example, the air blowing unit may include a row of nozzles which can be sway so as to blow air in different directions. In addition, it is not necessary that the air-blowing roller have a round cross section. It can be of any shape. As long as air can be directed to the fabric in a suitable direction, it is within the scope of the subject invention.

A major difference between embodiments of the subject invention and related art (e.g., including disclosures of above-mentioned patents and commercial products) rests with the system configuration of the robot. Embodiments provide a dual (or multi) robot manipulator system, while the related art references employ a single-manipulator system. The dual-manipulator configuration can grasp a fabric from selected ends or sides and control the tension applied to the grasped fabric. The provided robot system can keep the grasped fabric flattened through real-time sensing of tension (i.e., internal force) or visual information, even if an external force is applied to the fabric during the handling operation. Motion corrections can be implemented to maintain the desired configuration of the fabric. Such a sophisticated tension and motion control is not achievable by other single-manipulator systems, or by systems with less sophisticated control systems and methods. Embodiments provide enabling mechanical structures of the apparatus that are uniquely advantageous.

In certain embodiments, an advantage of the provided rolling-up end-effector is that it can pick up a piece of fabric material by suction together with coordinated movements of the end-effector and the robot manipulator in such a way that the unrolled fabric part can be maintained in its original position. This facilitates a more precise pick-and-place process for flexible sheets in general, because the fabric part is inhibited from shifting or slipping in the course of picking and placing. Such a coordinated movement, as realized by the provided motion control, provides unique benefits to commercial sewing and other operations.

In certain embodiments, a transmission mechanism comprising a pulley and belt is used to precisely control the end-effector, providing advantages of precision and improved clearance around the roller, allowing for the use of smaller rollers for more precise control. In other embodiments the roller is directly driven by the motor from one end, providing advantages of simplicity and cost reduction, and larger rollers are also advantageously employed to allow contact with the fabric without interference from the motor.

### Materials And Methods

All patents, patent applications, provisional applications, and publications referred to or cited herein are incorporated by reference in their entirety, including all figures and tables, to the extent they are not inconsistent with the explicit teachings of this specification.

In order that the present disclosure may be more readily understood, certain terms are defined below, and throughout the detailed description, to provide guidance as to their meaning as used herein.

As used herein, the terms “a,” “an,” “the” and similar terms used in the context of the subject invention are to be construed to cover both the singular and plural unless otherwise indicated herein or clearly contradicted by the context. Thus, for example, reference to “an arm” or “a hole” should be construed to cover or encompass both a singular arm or a singular hole and a plurality of arms and a plurality of holes, unless indicated otherwise or clearly contradicted by the context.

As used herein, the terms “about” and “approximately” shall generally mean an acceptable degree of error for the quantity measured given the nature or precision of the measurements. Exemplary degrees of error are within 20 percent (%), typically, within 10%, and more typically, within 5% of a given value or range of values.

As used herein, the term “and/or” should be understood to mean “either or both” of the features so conjoined, i.e., elements that are conjunctively present in some cases and disjunctively present in other cases.

As used herein, the terms “comprising”, “consisting of” and “consisting essentially of” are defined according to their standard meaning. The terms may be substituted for one another herein in order to attach the specific meaning associated with each term.

As used herein, the term “or” should be understood to have the same meaning as “and/or” as defined above. For example, when separating a listing of items, “and/or” or “or” shall be interpreted as being inclusive, i.e., the inclusion of at least one, but also including more than one, of a number of items and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e., “one or the other but not both”) when preceded by terms of exclusivity, such as “either,” “one of,” “only one of,” or “exactly one of.”

Following are examples that illustrate procedures for practicing the invention. These examples should not be construed as limiting. All percentages are by weight and all solvent mixture proportions are by volume unless otherwise noted.

### EXAMPLE 1

### Proposed Commercial Embodiments

The Product An embodiment of the subject invention is purposely designed to implement acquiring,

holding, positioning and releasing of fabric materials with a special capability of controlling the internal forces of the fabric in the course of manipulation. Combined with a computer vision system, this embodiment facilitates precision positioning warranted by fabric panel assembly, interlining fusing, sewing operations, among other garment handing processes, in such a way as to enhance productivity, improve positional accuracy and reduce defective products that otherwise leads to waste. Various commercialization opportunities exist for the current embodiment (and related embodiments), including but not limited to co-development with or licensing to garment manufacturer(s), or marketing the system as a standalone product in collaboration with an original equipment manufacturer (OEM) specialized in automation.

### The Market

The commercial garment industry is yet to be fully impacted by modern robotic technologies. One reason for the less prevalent use of robots in the garment production sector is that existing robotic devices that have been successfully adopted by other manufacturing sectors are not suitable for handling fabric materials that are intrinsically soft, flexible, and characterized by different textures. That is, the way that robots handle rigid components in an automobile factory does not fit apparel assembly processes due to the tendency of fabrics to change shape once manipulated.

The garment production process remains largely unchanged since the invention of the sewing machine and is still heavily dependent on a human workforce to complete most sewing and handling tasks. To reduce production costs, garment manufacturers worldwide hunt for cheaper labor and keep relocating to regions or countries with a lower wage such as Mainland China, Vietnam, and Bangladesh. Nevertheless, the global labor shortage and rising wages create economic pressures and automation technology will be the next frontier where garment manufacturers gain competitive edges. Major garment manufacturers have expressed interests in upgrading their labor-intensive production process by means of intelligent automation technologies.

### Competitive Analysis

The successful adoption of robots in the garment production sector hinges on several important factors. First of all, whether or not the cost of the robotic devices is justifiable in economic terms as compared to human labor cost for a given range of routine production tasks. The labor wages in developing countries are ever increasing whereas the selling price of industrial robot records a falling trend according to publicized figures. Rising wage has become an imminent financial challenge to most garment manufactures in the region, thereby motivating them to pursue automation solutions that can retain the cost-effectiveness of garment production.

Considering embodiments of the subject invention that are capable of handling fabric parts for various operations such as ply stacking and sewing, it could be deemed functionally equivalent to a sewing operator running two shifts (or up to 24 hours) per day in a production cell. Adding the cost associated with custom-made fixtures and the cost of catering and accommodation that are not required by the present system, the potential savings made possible by certain embodiments of the subject invention support financial investment.

Production costs of the subject invention vary with engineering specifications and actual volume of robotic manipulators and components to be procured. Still, it is estimated that a reasonable selling price of such system including the dual robot manipulators, rolling-up end-effectors and the vision unit should fall within the range of commercial viability, depending on the target profit margin and distribution costs.

A second factor is whether or not the subject invention can handle fabrics more effectively than other reported systems or commercial products on the market. Of the many robotic end-effectors revealed by the academic publications (e.g., as detailed above), the majority adopt mechanical grippers that utilize a “2-finger” construction. This is due largely to its prevalence in conventional robotic systems and its being readily available on the market. In spite of its simplicity in design, this type of end-effectors is faced with challenges in positioning the fabric precisely because other portions of the fabric, especially the edges and corners, can be left dangling and unconstrained. Adhesive grippers also suffer from the above issue, and also the difficulties in disengaging the fabric from the adhesive tapes without disrupting the fabric's position.

As regards the electro adhesion and air-flow types of end-effectors, it is apparent that they can be more able to constrain a larger surface area of the fabric, yet with a drawback being that the size of the end-effectors needs to be as large as the fabric parts to avoid loose ends interfering with the handling process. This can give rise to bulky end-effectors and limit the volume of the work envelope of the robotic system.

As opposed to the aforementioned related art end-effectors, the embodiments of the subject invention address the issues by ensuring that the fabric material, once acquired, is more thoroughly constrained throughout the handling process. That is, there are no (or fewer, or smaller) loose edges or corners and the tension of the fabric can be controlled to maintain a stretched (e.g., semi-rigid) state of the fabric that makes the recognition and positioning of the fabric by the robot system more readily achievable. On the other hand, the length of the present end-effectors can be varied to cater to a wider range of sizes of fabric panels as and when necessary without drastically increasing the footprint occupied by the end-effectors as in the case of the electro adhesion counterpart.

Another related art process (e.g., as developed by Sewbo, Inc.) aims to turn garment parts into more “rigid” objects, which could then be more effectively handled and visualized by conventional robots. The process involves extra treatment procedures including stiffening (setting the fabrics in a chemical), de-stiffening (rinsing in hot water) and drying, which inevitably add substantial processing time and cost to the production and render the whole process inefficient. This process is yet to be proven commercially effective.

Embodiments of the subject invention provide a novel physical design and working principle that are different from related art fabric-handling robotic devices and systems. Embodiments provide distinct advantages over the other systems in terms of stability of fabric handling, precision of positioning, and overall process efficiency. The current market landscape reveals very few established players in this field. Most garment automation facilities are empirically developed by garment manufacturers for in-house applications in the absence of robotics and computer vision expertise. The advent of the innovations provided by the present invention meets the demands of the garment manufacturers who are constantly looking for effective automation solutions to enhance both quality and productivity.

### EXEMPLIFIED EMBODIMENTS

The invention may be better understood by reference to certain illustrative examples, including but not limited to the following:

Embodiment 1. A fabric handling manipulator system for handling a subject fabric part, comprising:
a first robot manipulator;
a second robot manipulator;
a first rolling-up end-effector positioned by the first robot manipulator, the first rolling-up end-effector configured and adapted to grasp a first end of the subject fabric part with a roller having a suction port;
a second rolling-up end-effector positioned by the second robot manipulator, the second rolling-up end-effector configured and adapted to grasp a second end of the subject fabric part with a roller having a suction port;
a first force sensor configured and adapted to sense a force applied to the first rolling-up end-effector;
a second force sensor configured and adapted to sense a force applied to the second rolling-up end-effector; and
a vision sensor system configured and adapted to sense a fabric part pose of the subject fabric part, a first pose of the first rolling-up end-effector, and a second pose of the second rolling-up end-effector.

Embodiment 2. The fabric handling manipulator system of Embodiment 1, comprising a controller configured and adapted to simultaneously control the fabric part pose and a tension in the fabric part.

Embodiment 3. The fabric handling manipulator system of Embodiment 2, wherein the control is driven via the first robot manipulator and the second robot manipulator, according to inputs from the vision sensor system and one or both of the first force sensor and the second force sensor.

Embodiment 4. The fabric handling manipulator system of any of Embodiments 1-3, comprising:
a third robot manipulator;
a third rolling-up end-effector positioned by the third robot manipulator, the third rolling-up end-effector configured and adapted to grasp a third end of the subject fabric part with a roller having a suction port; and
a third force sensor configured and adapted to sense a force applied to the third rolling-up end-effector.

Embodiment 5. The fabric handling manipulator system of Embodiment 4, wherein the control is driven via the first robot manipulator, the second robot manipulator, and the third robot manipulator, according to inputs from the vision sensor system and two or more of the first force sensor, the second force sensor, and the third force sensor.

Embodiment 6. The fabric handling manipulator system of any of Embodiments 1-3, each of the first rolling-up end-effector and the second rolling-up end-effector, respectively, comprising a motor installed on the rolling-up end-effector and configured such that the motor torque can be transmitted through a suitable transmission mechanism to control a rotation of the roller.

Embodiment 7. The fabric handling manipulator system of any of Embodiments 4-5, each of the first rolling-up end-effector, the second rolling-up end-effector, and the third rolling-up end-effector, respectively, comprising a motor installed on the rolling-up end-effector and configured such that motor torque can be transmitted through a suitable transmission mechanism to control a rotation of the roller.

Embodiment 8. The fabric handling manipulator system of any of Embodiments 6-7, comprising a worktable configured and adapted to support the subject fabric part and a frame configured and adapted to support the vision system and at least two robot manipulators above the worktable.

Embodiment 9. The fabric handling manipulator system of any of Embodiments 1-8, wherein at least the first rolling-up end-effector comprises:
a shaft part affixed to a main body of the end-effector;
a hollow tubular structure within the shaft part;
the roller part mounted on the shaft through bearings so that it can rotate freely;
the suction port connecting an outer surface of the outer roller part to the hollow tubular structure within the shaft part; and
a vacuum source connected to one end of the shaft;
such that the rolling-up end-effector enables a combination of suction and rolling-up operations for the manipulation of fabrics.

Embodiment 10. The fabric handling manipulator system of Embodiment 9, wherein at least the first rolling-up end-effector comprises:
a planar end-effector mounting surface;
a multiplicity of mounting holes in the end-effector mounting surface, the mounting holes arranged around a primary axis of rotation running through the end-effector and substantially perpendicular to the planar end-effector mounting surface; and
a secondary axis of rotation, the roller and suction port rotatably mounted in alignment with the secondary axis;
wherein the primary axis of rotation crosses through and is substantially perpendicular to the secondary axis of rotation, such that the roller when oriented substantially parallel to a fabric working surface remains substantially parallel to the fabric working surface throughout a specified rotation of the end-effector around the primary axis.

Embodiment 11. A method for handling a subject fabric part, comprising:
providing the subject fabric part;
providing a fabric handling manipulator system according to any of Embodiments 1-10;
moving, by the first manipulator, the first end-effector such that the suction port comes into contact with a first end of the subject fabric part;
applying a suitable negative pressure or vacuum to the vacuum port, to hold the contacted area of the subject fabric part;
rotating the roller while translationally moving the end-effector in a direction and with a controlled displacement that creates a rolled-up portion of the subject fabric part around the roller without perturbating the rest of the subject fabric part.

Embodiment 12. The method of Embodiment 11, comprising:
further rotating the roller while translationally moving the end-effector in a direction and with a controlled displacement that increases the rolled-up portion of the subject fabric part around the roller sufficient to roll up all or substantially all of the subject fabric part, to create a rolled-up fabric;
lifting, by motion of the end-effector, the rolled-up fabric;
moving, by the manipulator, the end-effector to a target end-effector position;
placing, by the end-effector, the rolled-up fabric at a target fabric position; and
counter-rotating the roller while translationally moving the end-effector in a direction and with a controlled displacement that decreases the rolled-up portion of the subject fabric part around the roller sufficient to spread a portion of the rolled-up fabric, to create a placed fabric.

Embodiment 13. The method of Embodiment 12, comprising:
identifying, by the vision sensor system, a surface undulation caused by a twist, fold, or wrinkle in the subject fabric part; and
rotating or counter-rotating the roller or translationally moving the end-effector, or both, in a direction and with a controlled displacement that reduces or eliminates the surface undulation caused by the twist, fold, or wrinkle in the subject fabric part.

Embodiment 14. The method of Embodiment 12, comprising:
identifying, by monitoring a variation in force from the first force sensor, a surface undulation caused by a twist, fold, or wrinkle in the subject fabric part; and
rotating or counter-rotating the roller or translationally moving the end-effector, or both, in a direction and with a controlled displacement that reduces the variation in force from the first force sensor and reduces or eliminates the surface undulation caused by the twist, fold, or wrinkle in the subject fabric part.

Embodiment 15. A method for handling a subject fabric part, comprising:
providing the subject fabric part;
providing a fabric handling manipulator system, the fabric handling manipulator system comprising:
a first robot manipulator;
a second robot manipulator;
a first rolling-up end-effector positioned by the first robot manipulator, the first rolling-up end-effector configured and adapted to grasp a first end of the subject fabric part with a first roller having a first suction port;
a second rolling-up end-effector positioned by the second robot manipulator, the second rolling-up end-effector configured and adapted to grasp a second end of the subject fabric part with a second roller having a second suction port;
a first force sensor configured and adapted to sense a force applied to the first rolling-up end-effector;
a second force sensor configured and adapted to sense a force applied to the second rolling-up end-effector;
a vision sensor system configured and adapted to sense a fabric part pose of the subject fabric part, a first pose of the first rolling-up end-effector, and a second pose of the second rolling-up end-effector; and
a controller configured and adapted to simultaneously control the fabric part pose and a tension in the fabric part via the first robot manipulator and the second robot manipulator, according to inputs from the vision sensor system and one or both of the first force sensor and the second force sensor;
moving, by the first manipulator, the first end-effector such that the first suction port comes into contact with the first end of the subject fabric part;
applying a suitable negative pressure or vacuum to the first suction port, to hold the first end of the subject fabric part;
rotating the first roller while translationally moving the first end-effector in a direction and with a controlled displacement that creates a first rolled-up portion of the subject fabric part around the first roller without perturbating the rest of the subject fabric part;
moving, by the second manipulator, the second end-effector such that the second suction port comes into contact with the second end of the subject fabric part;
applying a suitable negative pressure or vacuum to the second suction port, to hold the second end of the subject fabric part; and
rotating the second roller while translationally moving the second end-effector in a direction and with a controlled displacement that creates a second rolled-up portion of the subject fabric part around the second roller without perturbating the rest of the subject fabric part.

Embodiment 16. The method of Embodiment 15, comprising:
further rotating each of the first and second rollers while translationally moving each of the first and second end-effectors in a respective direction and with a respectively controlled displacement that increases the rolled-up portion of the subject fabric part around each of the respective first and second rollers sufficient to roll up all or a further portion of the subject fabric part, to create a rolled-up fabric;
lifting, by coordinated motion of the respective first and second end-effectors, the rolled-up fabric;
moving, by coordinated motion of the respective first and second manipulators, the respective first and second end-effectors to respective first and second target end-effector positions;
placing, by the respective first and second end-effectors, the rolled-up fabric at a target fabric position; and
counter-rotating the respective first and second rollers while translationally moving the respective first and second end-effectors in a respective direction and with a respectively controlled displacement that decreases the rolled-up portion of the subject fabric part around the roller sufficient to spread a portion of the rolled-up fabric, to create a placed fabric.

Embodiment 17. The method of Embodiment 16, comprising:
identifying, by the vision sensor system, a surface undulation caused by a twist, fold, or wrinkle in the subject fabric part; and
rotating or counter-rotating one or both of the respective first and second rollers or translationally moving one or both of the respective first and second end-effectors, or both, in a respective direction and with a respectively controlled displacement that reduces or eliminates the surface undulation caused by the twist, fold, or wrinkle in the subject fabric part.

Embodiment 18. The method of Embodiment 16, comprising:
identifying, by monitoring a variation in force from the respective first and second force sensors, a surface undulation caused by a twist, fold, or wrinkle in the subject fabric part; and
rotating or counter-rotating the respective first and second rollers or translationally moving the respective first and second end-effectors, or both, in a respective direction and with a respectively controlled displacement that reduces a variation in force from the respective first and second force sensors and reduces or eliminates the surface undulation caused by the twist, fold, or wrinkle in the subject fabric part.

Embodiment 19. The method of Embodiment 16, comprising, during one or more of the steps of lifting, moving, or placing:
monitoring, the force from the respective first and second force sensors; and
controlling the rotation of the respective first and second rollers and translation of the respective first and second end-effectors, to create a target level of tension in the subject fabric part.

Embodiment 20. The method of Embodiment 19, comprising controlling the target level of tension in the subject fabric part while conducting a sewing operation on the fabric part.

Embodiment 21. The method of any one of the previous Embodiments 11-19, further comprising:
blowing air in a direction to induce vibratory motions of the fabric before applying a suitable negative pressure or vacuum to the vacuum port, to hold the contacted area of the subject fabric part.

Embodiment 22. The method of Embodiment 21, further comprising:
changing the direction in which the air is blown.

Embodiment 23. A fabric handling manipulator system for handling a subject fabric part, comprising:
a first robot manipulator;
a second robot manipulator;
a first rolling-up end-effector positioned by the first robot manipulator, the first rolling-up end-effector configured and adapted to grasp a first end of the subject fabric part with a first roller having a first suction port;
a second rolling-up end-effector positioned by the second robot manipulator, the second rolling-up end-effector configured and adapted to grasp a second end of the subject fabric part with a second roller having a second suction port;
a first force sensor configured and adapted to sense a force applied to the first rolling-up end-effector;
a second force sensor configured and adapted to sense a force applied to the second rolling-up end-effector;
a vision sensor system configured and adapted to sense a fabric part pose of the subject fabric part, a first pose of the first rolling-up end-effector, and a second pose of the second rolling-up end-effector; and
a controller configured and adapted to simultaneously control the fabric part pose and a tension in the fabric part via the first robot manipulator and the second robot manipulator, according to inputs from the vision sensor system and one or both of the first force sensor and the second force sensor.

Embodiment 24. The fabric handling manipulator system of Embodiment 23, each of the first rolling-up end-effector and the second rolling-up end-effector, respectively, comprising a motor installed on the rolling-up end-effector and configured such that the motor torque can be transmitted through a suitable transmission mechanism to control a rotation of the roller; and the system comprising a worktable configured and adapted to support the subject fabric part and a frame configured and adapted to support the vision system and at least two robot manipulators above the worktable.

Embodiment 25. The fabric handling manipulator system of Embodiment 23, wherein at least the first rolling-up end-effector comprises:
a shaft part affixed to a main body of the end-effector;
a hollow tubular structure within the shaft part;
the roller part mounted on the shaft through bearings so that it can rotate freely;
the suction port connecting an outer surface of the outer roller part to the hollow tubular structure within the shaft part; and
a vacuum source connected to one end of the shaft;
such that the rolling-up end-effector enables a combination of suction and rolling-up operations for the manipulation of fabrics.

Embodiment 26. The fabric handling manipulator system of Embodiment 23, wherein at least the first rolling-up end-effector comprises:
a planar end-effector mounting surface;
a multiplicity of mounting holes in the end-effector mounting surface, the mounting holes arranged around a primary axis of rotation running through the end-effector and perpendicular to the planar end-effector mounting surface; and
a secondary axis of rotation, the roller and suction port rotatably mounted in alignment with the secondary axis;
wherein the primary axis of rotation crosses through and is substantially perpendicular to the secondary axis of rotation, such that the roller when oriented substantially parallel to a fabric working surface remains substantially parallel to the fabric working surface throughout a specified rotation of the end-effector around the primary axis.

Embodiment 27. The fabric handling manipulator system of any one of Embodiments 23-26, wherein the first rolling-up end-effector and/or the second rolling-up end-effector further comprises:
an air-blowing unit configured to blow air in a direction.

Embodiment 28, The fabric handling manipulator system of Embodiment 27, wherein the air-blowing unit comprises an air-blowing roller, on the circumference of the air-blowing roller, at least one opening for blowing the air is formed.

Embodiment 29. The fabric handling manipulator system of Embodiment 28, wherein the air-blowing roller is rotatable by a motor installed on the end-effector and configured such that the motor torque can be transmitted through a transmission mechanism to change the direction in which the air is blown.

Although the subject invention has been illustrated and described herein with reference to preferred embodiments and specific examples thereof, it will be readily apparent to those of ordinary skill in the art that other embodiments and examples may perform similar functions and/or achieve like results.

It should be understood that the examples and embodiments described herein are for illustrative purposes only and that various modifications or changes in light thereof will be suggested to persons skilled in the art and are to be included within the spirit and purview of this application and the scope of the appended claims. In addition, any elements or limitations of any invention or embodiment thereof disclosed herein can be combined with any and/or all other elements or limitations (individually or in any combination) or any other invention or embodiment thereof disclosed herein, and all such combinations are contemplated with the scope of the invention without limitation thereto.

### REFERENCES

[1.] J. Schrimpf, M. Bjerkeng, M. Lind and G. Mathisen, “Model-based feed-forward and setpoint generation in a multi-robot sewing cell,” 2015 IEEE International Conference on Robotics and Automation (ICRA), 2015, pp. 2027-2033, doi: 10.1109/ICRA.2015.7139464. https: //ieeexplore.ieee.org/abstract/document/7139464

[2.] J. Stria et al., “Garment perception and its folding using a dual-arm robot,” 2014 IEEE/RSJ International Conference on Intelligent Robots and Systems, 2014, pp. 61-67, doi: 10.1109/IROS.2014.6942541. https://ieeexplore.ieee.org/document/6942541

[3.] L. Sun, G. Aragon-Camarasa, S. Rogers and J.P. Siebert, “Accurate garment surface analysis using an active stereo robot head with application to dual-arm flattening,” 2015 IEEE International Conference on Robotics and Automation (ICRA), 2015, pp. 185-192, doi: 10.1109/ICRA.2015.7138998. https://ieeexplore.ieee.org/document/7138998

[4.] M. Shibata, T. Ota and S. Hirai, “Virtual rope theory for fabric manipulation,” 2009 IEEE International Symposium on Assembly and Manufacturing, 2009, pp. 28-33, doi: 10.1109/ISAM.2009.5376934. https://ieeexplore.ieee.org/document/5376934

[5.] M. Shibata and S. Hirai, “Fabric manipulation utilizing contacts with the environment,” 2012 IEEE International Conference on Automation Science and Engineering (CASE), 2012, pp. 442-447, doi: 10.1109/CoASE.2012.6386350. https://ieeexplore.ieee.org/abstract/document/6386350

[6.] M. Aranda, J. Antonio Corrales Ramon, Y. Mezouar, A. Bartoli and E. Özgür, “Monocular Visual Shape Tracking and Servoing for Isometrically Deforming Objects,” 2020 IEEE/RSJ International Conference on Intelligent Robots and Systems (IROS), 2020, pp. 7542-7549, doi: 10.1109/IROS45743.2020.9341646. https://ieeexplore.ieee.org/document/9341646

[7.] D. Tanaka, S. Arnold and K. Yamazaki, “Disruption-Resistant Deformable Object Manipulation on Basis of Online Shape Estimation and Prediction-Driven Trajectory Correction,” in IEEE Robotics and Automation Letters, vol. 6, no. 2, pp. 3809-3816, April 2021, doi: 10.1109/LRA.2021.3060679. https://iecexplore.ieee.org/document/9359332

[8.] S. Ku, J. Myeong, H.-Y. Kim and Y.-L. Park, “Delicate Fabric Handling Using a Soft Robotic Gripper With Embedded Microneedles,” in IEEE Robotics and Automation Letters, vol. 5, no. 3, pp. 4852-4858, July 2020, doi: 10.1109/LRA.2020.3004327. https://ieeexplore.ieee.org/abstract/document/9123593

[9.] K. Yamazaki and T. Abe, “A Versatile End-Effector for Pick-and-Release of Fabric Parts,” in IEEE Robotics and Automation Letters, vol. 6, no. 2, pp. 1431-1438, April 2021, doi: 10.1109/LRA.2021.3057053. https://ieeexplore.ieee.org/document/9345958

[10.] D. Hinwood, D. Herath and R. Goecke, “Towards the Design of a Human-Inspired Gripper for Textile Manipulation,” 2020 IEEE 16th International Conference on Automation Science and Engineering (CASE), 2020, pp. 913-920, doi: 10.1109/CASE48305.2020.9216964. https://ieeexplore.ieee.org/abstract/document/9216964

[11.] B. Sun and X. Zhang, “A New Electrostatic Gripper for Flexible Handling of Fabrics in Automated Garment Manufacturing,” 2019 IEEE 15th International Conference on Automation Science and Engineering (CASE), 2019, pp. 879-884, doi: 10.1109/COASE.2019.8843149. https://ieeexplore.ieee.org/document/8843149

[12.] Babur Ozcelik Fehmi Erzincanli Fehim Findik, (2003),“Evaluation of handling results of various materials using a non-contact end-effector” Industrial Robot: An International Journal, Vol. 30 Iss 4 pp. 363-369. http://dx.doi.org/10.1108/01439910310479630

[13.] J.K. Parker, R. Dubey, F.W. Paul, R.J. Becker “Robotic fabric handling for automating garment manufacturing”, Journal of Engineering for Industry, vol. 105, 1983, pp. 21-26.

1. A fabric handling manipulator system for handling a subject fabric part, comprising:
a first robot manipulator;
a second robot manipulator;
a first rolling-up end-effector positioned by the first robot manipulator, the first rolling-up end-effector configured and adapted to grasp a first end of the subject fabric part with a roller having a suction port;
a second rolling-up end-effector positioned by the second robot manipulator, the second rolling-up end-effector configured and adapted to grasp a second end of the subject fabric part with a roller having a suction port;
a first force sensor configured and adapted to sense a force applied to the first rolling-up end-effector;
a second force sensor configured and adapted to sense a force applied to the second rolling-up end-effector; and
a vision sensor system configured and adapted to sense a fabric part pose of the subject fabric part, a first pose of the first rolling-up end-effector, and a second pose of the second rolling-up end-effector.

2. The fabric handling manipulator system of claim 1, comprising a controller configured and adapted to simultaneously control the fabric part pose and a tension in the fabric part.

3. The fabric handling manipulator system of claim 2, wherein the control is driven via the first robot manipulator and the second robot manipulator, according to inputs from the vision sensor system and one or both of the first force sensor and the second force sensor.

4. The fabric handling manipulator system of claim 1, comprising:
a third robot manipulator;
a third rolling-up end-effector positioned by the third robot manipulator, the third rolling-up end-effector configured and adapted to grasp a third end of the subject fabric part with a roller having a suction port; and
a third force sensor configured and adapted to sense a force applied to the third rolling-up end-effector.

5. The fabric handling manipulator system of claim 4, wherein the control is driven via the first robot manipulator, the second robot manipulator, and the third robot manipulator, according to inputs from the vision sensor system and two or more of the first force sensor, the second force sensor, and the third force sensor.

6. The fabric handling manipulator system of claim 1 wherein each of the first rolling-up end-effector and the second rolling-up end-effector, respectively, comprising a motor installed on the rolling-up end-effector and configured such that the motor torque can be transmitted through a transmission mechanism to control a rotation of the roller.

7. The fabric handling manipulator system of claim 4 wherein each of the first rolling-up end-effector, the second rolling-up end-effector, and the third rolling-up end-effector, respectively, comprising a motor installed on the rolling-up end-effector and configured such that motor torque can be transmitted through a suitable transmission mechanism to control a rotation of the roller.

8. The fabric handling manipulator system of claim 6, further comprising a worktable configured and adapted to support the subject fabric part and a frame configured and adapted to support the vision system and at least two robot manipulators above the worktable.

9. The fabric handling manipulator system of claim 1, wherein at least the first rolling-up end-effector comprises:
a shaft part affixed to a main body of the end-effector;
a hollow tubular structure within the shaft part;
the roller part mounted on the shaft through bearings so that it can rotate freely;
the suction port connecting an outer surface of the outer roller part to the hollow tubular structure within the shaft part; and
a vacuum source connected to one end of the shaft;
such that the rolling-up end-effector enables a combination of suction and rolling-up operations for the manipulation of fabrics.

10. The fabric handling manipulator system of claim 9, wherein at least the first rolling-up end-effector comprises:
a planar end-effector mounting surface;
a multiplicity of mounting holes in the end-effector mounting surface, the mounting holes arranged around a primary axis of rotation running through the end-effector and substantially perpendicular to the planar end-effector mounting surface; and
a secondary axis of rotation, the roller and suction port rotatably mounted in alignment with the secondary axis;
wherein the primary axis of rotation crosses through and is substantially perpendicular to the secondary axis of rotation, such that the roller when oriented substantially parallel to a fabric working surface remains substantially parallel to the fabric working surface throughout a specified rotation of the end-effector around the primary axis.

11. The fabric handling manipulator system of claim 1, wherein the first rolling-up end-effector and/or the second rolling-up end-effector further comprises:
an air-blowing unit configured to blow air in a direction.

12. The fabric handling manipulator system of claim 11, wherein the air-blowing unit comprises an air-blowing roller, on the circumference of the air-blowing roller, at least one opening for blowing the air is formed.

13. The fabric handling manipulator system of claim 12, wherein the air-blowing roller is rotatable to change the direction in which the air is blown.

14. A method for handling a subject fabric part, comprising:
providing the subject fabric part;
providing a fabric handling manipulator system according to claim 1;
moving, by the first manipulator, the first end-effector such that the suction port comes into contact with a first end of the subject fabric part;
applying a suitable negative pressure or vacuum to the vacuum port, to hold the contacted area of the subject fabric part;
rotating the roller while translationally moving the end-effector in a direction and with a controlled displacement that creates a rolled-up portion of the subject fabric part around the roller without perturbating the rest of the subject fabric part.

15. The method of claim 14, comprising:
further rotating the roller while translationally moving the end-effector in a direction and with a controlled displacement that increases the rolled-up portion of the subject fabric part around the roller sufficient to roll up all or substantially all of the subject fabric part, to create a rolled-up fabric;
lifting, by motion of the end-effector, the rolled-up fabric;
moving, by the manipulator, the end-effector to a target end-effector position;
placing, by the end-effector, the rolled-up fabric at a target fabric position; and
counter-rotating the roller while translationally moving the end-effector in a direction and with a controlled displacement that decreases the rolled-up portion of the subject fabric part around the roller sufficient to spread a portion of the rolled-up fabric, to create a placed fabric.

16. The method of claim 15, comprising:
identifying, by the vision sensor system, a surface undulation caused by a twist, fold, or wrinkle in the subject fabric part; and
rotating or counter-rotating the roller or translationally moving the end-effector, or both, in a direction and with a controlled displacement that reduces or eliminates the surface undulation caused by the twist, fold, or wrinkle in the subject fabric part.

17. The method of claim 15, comprising:
identifying, by monitoring a variation in force from the first force sensor, a surface undulation caused by the twist, fold, or wrinkle in the subject fabric part; and
rotating or counter-rotating the roller or translationally moving the end-effector, or both, in a direction and with a controlled displacement that reduces the variation in force from the first force sensor and reduces or eliminates the surface undulation caused by the twist, fold, or wrinkle in the subject fabric part.

18. The method of claim 14, further comprising:
blowing air in a direction to induce vibratory motions of the fabric before applying a suitable negative pressure or vacuum to the vacuum port, to hold the contacted area of the subject fabric part.

19. The method of claim 18, further comprising:
changing the direction in which the air is blown.

20. A method for handling a subject fabric part, comprising:
providing the subject fabric part;
providing a fabric handling manipulator system, the fabric handling manipulator system comprising:
a first robot manipulator;
a second robot manipulator;
a first rolling-up end-effector positioned by the first robot manipulator, the first rolling-up end-effector configured and adapted to grasp a first end of the subject fabric part with a first roller having a first suction port;
a second rolling-up end-effector positioned by the second robot manipulator, the second rolling-up end-effector configured and adapted to grasp a second end of the subject fabric part with a second roller having a second suction port;
a first force sensor configured and adapted to sense a force applied to the first rolling-up end-effector;
a second force sensor configured and adapted to sense a force applied to the second rolling-up end-effector;
a vision sensor system configured and adapted to sense a fabric part pose of the subject fabric part, a first pose of the first rolling-up end-effector, and a second pose of the second rolling-up end-effector; and
a controller configured and adapted to simultaneously control the fabric part pose and a tension in the fabric part via the first robot manipulator and the second robot manipulator, according to inputs from the vision sensor system and one or both of the first force sensor and the second force sensor;
moving, by the first manipulator, the first end-effector such that the first suction port comes into contact with the first end of the subject fabric part;
applying a negative pressure or vacuum to the first suction port, to hold the first end of the subject fabric part;
rotating the first roller while translationally moving the first end-effector in a direction and with a controlled displacement that creates a first rolled-up portion of the subject fabric part around the first roller without perturbating the rest of the subject fabric part;
moving, by the second manipulator, the second end-effector such that the second suction port comes into contact with the second end of the subject fabric part;
applying a suitable negative pressure or vacuum to the second suction port, to hold the second end of the subject fabric part; and
rotating the second roller while translationally moving the second end-effector in a direction and with a controlled displacement that creates a second rolled-up portion of the subject fabric part around the second roller without perturbating the rest of the subject fabric part.

21. The method of claim 20, comprising:
further rotating each of the first and second rollers while translationally moving each of the first and second end-effectors in a respective direction and with a respectively controlled displacement that increases the rolled-up portion of the subject fabric part around each of the respective first and second rollers sufficient to roll up all or a further portion of the subject fabric part, to create a rolled-up fabric;
lifting, by coordinated motion of the respective first and second end-effectors, the rolled-up fabric;
moving, by coordinated motion of the respective first and second manipulators, the respective first and second end-effectors to respective first and second target end-effector positions;
placing, by the respective first and second end-effectors, the rolled-up fabric at a target fabric position; and
counter-rotating the respective first and second rollers while translationally moving the respective first and second end-effectors in a respective direction and with a respectively controlled displacement that decreases the rolled-up portion of the subject fabric part around the roller sufficient to spread a portion of the rolled-up fabric, to create a placed fabric.

22. The method of claim 21, comprising:
identifying, by the vision sensor system, a surface undulation caused by a twist, fold, or wrinkle in the subject fabric part; and
rotating or counter-rotating one or both of the respective first and second rollers or translationally moving one or both of the respective first and second end-effectors, or both, in a respective direction and with a respectively controlled displacement that reduces or eliminates the surface undulation caused by the twist, fold, or wrinkle in the subject fabric part.

23. The method of claim 21, comprising:
identifying, by monitoring a variation in force from the respective first and second force sensors, a surface undulation caused by a twist, fold, or wrinkle in the subject fabric part; and
rotating or counter-rotating the respective first and second rollers or translationally moving the respective first and second end-effectors, or both, in a respective direction and with a respectively controlled displacement that reduces a variation in force from the respective first and second force sensors and reduces or eliminates the surface undulation caused by the twist, fold, or wrinkle in the subject fabric part.

24. The method of claim 21, comprising, during one or more of the steps of lifting, moving, or placing:
monitoring, the force from the respective first and second force sensors; and
controlling the rotation of the respective first and second rollers and translation of the respective first and second end-effectors, to create a target level of tension in the subject fabric part.

25. The method of claim 24, comprising controlling the target level of tension in the subject fabric part while conducting a sewing operation on the fabric part.

26. The method of claim 20, wherein the first and/or second rolling-up end-effector further comprising an air-blowing unit configured to blow air in a direction, and the method further comprises:
blowing air in a direction to induce vibratory motions of the fabric before applying a negative pressure or vacuum to the first and/or second suction port.

27. The method of claim 26, further comprises: after lifting the rolled-up fabric, changing the direction in which the air is blown so that the air is blown toward a fabric right below the rolled-up fabric.

28. A fabric handling manipulator system for handling a subject fabric part, comprising:
a first robot manipulator;
a second robot manipulator;
a first rolling-up end-effector positioned by the first robot manipulator, the first rolling-up end-effector configured and adapted to grasp a first end of the subject fabric part with a first roller having a first suction port;
a second rolling-up end-effector positioned by the second robot manipulator, the second rolling-up end-effector configured and adapted to grasp a second end of the subject fabric part with a second roller having a second suction port;
a first force sensor configured and adapted to sense a force applied to the first rolling-up end-effector;
a second force sensor configured and adapted to sense a force applied to the second rolling-up end-effector;
a vision sensor system configured and adapted to sense a fabric part pose of the subject fabric part, a first pose of the first rolling-up end-effector, and a second pose of the second rolling-up end-effector; and
a controller configured and adapted to simultaneously control the fabric part pose and a tension in the fabric part via the first robot manipulator and the second robot manipulator, according to inputs from the vision sensor system and one or both of the first force sensor and the second force sensor.

29. The fabric handling manipulator system of claim 28, each of the first rolling-up end-effector and the second rolling-up end-effector, respectively, comprising a motor installed on the rolling-up end-effector and configured such that the motor torque can be transmitted through a suitable transmission mechanism to control a rotation of the roller; and the system comprising a worktable configured and adapted to support the subject fabric part and a frame configured and adapted to support the vision system and at least two robot manipulators above the worktable.

30. The fabric handling manipulator system of claim 29, wherein at least the first rolling-up end-effector comprises:
a shaft part affixed to a main body of the end-effector;
a hollow tubular structure within the shaft part;
the roller part mounted on the shaft through bearings so that it can rotate freely;
the suction port connecting an outer surface of the outer roller part to the hollow tubular structure within the shaft part; and
a vacuum source connected to one end of the shaft;
such that the rolling-up end-effector enables a combination of suction and rolling-up operations for the manipulation of fabrics.

31. The fabric handling manipulator system of claim 30, wherein at least the first rolling-up end-effector comprises:
a planar end-effector mounting surface;
a multiplicity of mounting holes in the end-effector mounting surface, the mounting holes arranged around a primary axis of rotation running through the end-effector and perpendicular to the planar end-effector mounting surface; and
a secondary axis of rotation, the roller and suction port rotatably mounted in alignment with the secondary axis;
wherein the primary axis of rotation crosses through and is substantially perpendicular to the secondary axis of rotation, such that the roller when oriented substantially parallel to a fabric working surface remains substantially parallel to the fabric working surface throughout a specified rotation of the end-effector around the primary axis.

32. The fabric handling manipulator system of claim 28, wherein the first rolling-up end-effector and/or the second rolling-up end-effector further comprises:
an air-blowing unit configured to blow air in a direction.

33. The fabric handling manipulator system of claim 32, wherein the air-blowing unit comprises an air-blowing roller, on the circumference of the air-blowing roller, at least one opening for blowing the air is formed.

34. The fabric handling manipulator system of claim 33, wherein the air-blowing roller is rotatable by a motor installed on the end-effector and configured such that the motor torque can be transmitted through a transmission mechanism to change the direction in which the air is blown.

35. A fabric handling manipulator system for handling a subject fabric part, comprising:
a first robot manipulator;
a first rolling-up end-effector positioned by the first robot manipulator, the first rolling-up end-effector configured and adapted to grasp a first end of the subject fabric part with a first roller having a first suction port;
a first force sensor configured and adapted to sense a force applied to the first rolling-up end-effector;
a vision sensor system configured and adapted to sense a fabric part pose of the subject fabric part and a first pose of the first rolling-up end-effector; and
a controller configured and adapted to simultaneously control the fabric part pose and a tension in the fabric part via the first robot manipulator according to inputs from the vision sensor system and the first force sensor.
